(19) United States
(12) Patent Application Publication
(10) Pub. No.: US 2019/0155603 A1
(43) Pub. Date: May 23, 2019

(54) SYSTEM AND METHOD FOR MULTIPLEXING VECTOR COMPARE

(71) Applicant: Intel Corporation, Santa Clara, CA (US)

(72) Inventors: Micah VILLMOW, Santa Clara, CA (US); Mohammad A. ABDALLAH, Folsom, CA (US)

(21) Appl. No.: 16/313,838

(22) PCT Filed: Jul. 24, 2017
(86) PCT No.: PCT/US2017/043562

§ 371 Date: Dec. 27, 2018

Related U.S. Application Data
(60) Provisional application No. 62/367,558, filed on Jul. 27, 2016.

(51) Int. Cl. G06F 9/30; G06F 9/38

(52) U.S. Cl. CPC G06F 9/30036; G06F 9/3887; G06F 9/3848; G06F 9/30029; G06F 9/30021

(57) ABSTRACT

System and method for multiplexing vector comparison. The system and method access a first vector having a vector length. The first vector includes a plurality of vector portions having a vector portion length. In addition, the method accesses a second vector of the vector length. The second vector includes the same quantity of vector portions as the plurality of vector portions, and the vector portions of the second vector are of the vector portion length. The method further includes performing a comparison of each of the plurality of vector portions of the first vector to each of the plurality of vector portions of the second vector and storing a result of the comparing in a third vector with at least one bit of the third vector corresponding to each comparison of the vector portions.

### CROSS-REFERENCE TO RELATED APPLICATIONS

This application claims the benefit of U.S. Provisional Application No. 62/367,558, filed 27 Jul. 2016, which is hereby incorporated by reference.

### TECHNICAL FIELD

Embodiments of the present invention relate to the field of electronic applications for mobile computer systems. More specifically, embodiments of the present invention relate to systems and methods for multiplexing vector mask matches.

### BACKGROUND

In instruction sets, vectors are a set of bits that are used in bitwise operations. In many cases it is useful to compare sequences or patterns of bit values. Comparisons can be made between sets of bits to determine whether a first pattern of bits occurs within a second pattern of bits. Comparisons of bit values within a vector or between portions of vectors are known or referred to as vector compares.

A vector comparison compares each bit of a first vector to each bit of a second vector in their respective positions within each vector. For example, a 64-bit register is compared to another 64-bit register. The two vectors match if both vectors have the same values, i.e., zero or one bits in the same corresponding positions. A comparison of a portion of a first vector to other equal-length portions of the second vector generally requires a loop of vector comparisons. For example, determining if a second 64-bit vector includes a specific 8-bit pattern, aligned on octet (byte) boundaries, may require a loop comparing each octet (eight bits) of the second 64-bit vector, e.g., bits 0-7, 8-15, 16-23, etc., to an 8-bit pattern in the first vector. As may be seen, this type of comparison requires many more comparisons in an iterative (looping) process.

A further comparison of multiple portions of a first vector with equal-length portions of a second vector may require an additional loop. For example, to determine if any eight octets of a first 64-bit pattern have same pattern as any octets of a second 64-bit pattern may require a loop that increments through the eight octets of the first pattern surrounding the previous loop. Such a comparison may typically require 16 one-octet comparison operations. Such comparisons are typically performed by a series of “if-then-(else)” statements, for example, in a loop. Such software implementations are considered to be slow, as every possible comparison must be performed. In addition, such comparisons are often mispredicted by branch-prediction features of processors, resulting in degraded performance of such comparisons.

### BRIEF DESCRIPTION OF THE DRAWINGS

The present disclosure is illustrated by way of example and not limitation in the figures of the accompanying drawings, in which like references indicate similar elements and in which:

FIG. 1A is a block diagram of one embodiment of an example electronic system for execution of multiplexing vector mask operations.

FIG. 1B is a diagram of one embodiment of an example processor for execution of multiplexing vector mask instructions.

FIG. 1C is a diagram of one embodiment of a processor executing an example multiplexing vector mask instruction.

FIG. 2 is a diagram of one embodiment of example pseudo code that illustrates operation of a multiplex vector compare.

FIG. 3 is a diagram of one embodiment of an example multiplexing vector compare operation in which there are no matches.

FIG. 4 is a diagram of one embodiment of an example multiplexing vector compare operation in which there is one match.

FIG. 5 is a diagram of one embodiment of an example multiplexing vector compare operation in which there are multiple matches.

FIG. 6A is a diagram of one embodiment of an example computer-implemented method for multiplexing vector compare operations.

FIG. 6B is a diagram of one embodiment of a process for the execution of the multiplexing vector matching operation.

FIG. 7 is a diagram of one embodiment of example pseudo code that illustrates operation of a multiplex vector mask match operation.

FIG. 8 is a diagram of one embodiment of an example multiplex vector mask match operation in which there are no matches.

FIG. 9 is a diagram of one embodiment of an example multiplex vector mask match operation in which there is one match.

FIG. 10 is a diagram of one embodiment of an example multiplex vector mask match operation in which there are multiple matches.

FIG. 11 is a diagram of one embodiment of an example assembly language mnemonics of a single machine language instruction to implement a multiplexing vector compare operation, and of a single machine language instruction to implement a multiplexing vector mask match operation.

FIGS. 12A-12B are block diagrams of one embodiment illustrating a generic vector friendly instruction format and instruction templates thereof.

FIG. 12A is a block diagram of one embodiment illustrating a generic vector friendly instruction format and class A instruction templates thereof.

FIG. 12B is a block diagram of one embodiment illustrating the generic vector friendly instruction format and class B instruction templates thereof.

FIG. 13A is a block diagram of one embodiment illustrating an exemplary specific vector friendly instruction format.

FIG. 13B is a block diagram of one embodiment illustrating the fields of the specific vector friendly instruction format 1300 that make up the full opcode field 1274.

FIG. 13C is a block diagram of one embodiment illustrating the fields of the specific vector friendly instruction format 1300 that make up the register index field 1244.

FIG. 13D is a block diagram of one embodiment illustrating the fields of the specific vector friendly instruction format 1300 that make up the augmentation operation field 1250.

FIG. 14 is a block diagram of one embodiment of a register architecture 1400.

FIG. 15A is a block diagram of one embodiment illustrating both an exemplary in-order pipeline and an exemplary register renaming, out-of-order issue/execution pipeline.

FIG. 15B is a block diagram of one embodiment illustrating both an exemplary embodiment of an in-order architecture core and an exemplary register renaming, out-of-order issue/execution architecture core to be included in a processor.

FIGS. 16A-B illustrate a block diagram of one embodiment of a more specific exemplary in-order core architecture, which core would be one of several logic blocks (including other cores of the same type and/or different types) in a chip.

FIG. 16A is a block diagram of one embodiment of a single processor core, along with its connection to the on-die interconnect network 1602 and with its local subset of the Level 2 (L2) cache 1604.

FIG. 16B is an expanded view of one embodiment of part of the processor core in FIG. 16A.

FIG. 17 is a block diagram of one embodiment of a processor 1700 that may have more than one core, may have an integrated memory controller, and may have integrated graphics.

FIGS. 18-21 are block diagrams of one embodiment of exemplary computer architectures.

FIG. 18 shown a block diagram of one embodiment of a system.

FIG. 19 is a block diagram of one embodiment of a first more specific exemplary system.

FIG. 20 is a block diagram of one embodiment of a second more specific exemplary system.

FIG. 21 is a block diagram of one embodiment of a SoC.

FIG. 22 is a block diagram of one embodiment contrasting the use of a software instruction converter to convert binary instructions in a source instruction set to binary instructions in a target instruction set.

### DETAILED DESCRIPTION

The embodiments provide methods and systems for performing multiplexing vector compares. In particular, the embodiments provide methods and systems for performing multiplexing vector compares in a single machine language instruction. Further, the embodiments provide methods and systems for performing multiplexing vector compares that eliminate the overhead of branch predictions. The embodiments also provide multiplexing vector compares that are compatible and complementary with existing systems and methods of processor design, programming, and operation.

The methods are computer-implemented and include accessing a first vector having a vector length. The first vector includes a plurality of vector portions having a vector portion length. In addition, the method includes accessing a second vector of the vector length. The second vector includes the same quantity of vector portions as the plurality of vector portions, and the vector portions of the second vector are of the vector portion length. The method further includes comparing each of the plurality of vector portions of the first vector to each of the plurality of vector portions of the second vector and storing a result of the comparing in a third vector with at least one bit of the third vector corresponding to each comparison of the vector portions.

In further embodiments, a computer processor or similar processing device is configured to perform a multiplexing vector compare operation responsive to execution of one machine language instruction. The processing device may include hardware to perform all comparisons required by the multiplexing vector compare operation in parallel.

In accordance with another embodiment, a computer-readable medium is provided having instructions stored thereon that, responsive to execution by a processing device cause the processing device to perform operations including accessing a first vector having a vector length and accessing a second vector of the vector length. The first vector includes a plurality of vector portions having a vector portion length. The second vector includes the same quantity of vector portions as the plurality of first vector portions. The vector portions of the second vector are of the same vector portion length. The operations further include performing comparing each of the plurality of vector portions of the first vector to each of the plurality of vector portions of the second vector and storing a result of the comparing in a third vector with at least one bit of the third vector corresponding to each of the comparisons of the vector portions.

The embodiments are described with reference to detailed embodiments and examples, which are illustrated in the accompanying drawings. While the embodiments may be described in conjunction with these illustrations and examples, it would be understood by one of ordinary skill in the art that the embodiments are not limited by these examples, which are provide by way of explanation and not limitation. On the contrary, the embodiments encompass alternatives, modifications and equivalents, as would be understood by one skilled in the art consistent with the principles, structures and processes described herein. Furthermore, in the following detailed description, numerous specific details are set forth in order to provide a thorough understanding of the embodiments. However, it will be recognized by one of ordinary skill in the art that the embodiments may be practiced without these specific details. In other instances, well known methods, procedures, components, and circuits have not been described in detail as not to unnecessarily obscure aspects of the embodiments.

### NOMENCLATRE

Some portions of the detailed descriptions which follow are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed instruction, logic block, process, or similar element is considered to be a self-consistent sequence of functions, operations or instructions leading to a desired result. The functions, operations or instructions involve manipulations of quantities. These quantities can take the form of electrical or magnetic signals capable of being stored, transferred, combined, compared, and otherwise manipulated in a processing device, computing system or similar context. It has proven convenient at times, principally for reasons of common usage, to refer to these signals as bits, values, elements, symbols, characters, terms, numbers, data, or the like.

It should be borne in mind, however, that all of these and similar terms are to be associated with the appropriate quantities and may be considered labels applied to these quantities. Unless specifically stated otherwise as apparent from the following discussions, it is appreciated that throughout the described embodiments, discussions utilizing terms such as “resolving,” “accepting.” “selecting.” “determining.” “displaying.” “presenting.” “computing.” “sending.” “receiving.” “reducing.” “detecting.” “setting.” “accessing.” “placing.” “testing.” “forming.” “mounting.” “removing.” “ceasing.” “stopping.” “coating.” “processing.” “performing.” “generating.” “adjusting.” “creating.” “executing.” “continuing.” “indexing.” “translating.” “calculating.” “measuring.” “gathering.” “running.” or the like, refer to the action and processes of, or under the control of, a processing device and/or computer system, or similar electronic computing device, that manipulates and transforms data represented as electronic quantities within the computer system's registers and memories into other data similarly represented as electronic quantities within the processing device and computer system memories or registers or other such information storage, transmission or display devices.

One or more aspects of at least one embodiment may be implemented by representative instructions stored on a non-transitory, “machine-readable” or “computer-readable” medium which represents various logic within the processor, which when read by a machine causes the machine to fabricate logic to perform the techniques described herein. Such representations, which may be generally referred to as “IP cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

The terms “machine code,” “binary machine code,” and/or “binary code” refer to a hardware-dependent programming language in a processor's instruction set. Such machine code is typically the result of compiling a program written in a high-level language or assembling (and potentially linking) a program written in processor-dependent assembly language.

The term “microcode” is used herein to refer to a layer of hardware-level instructions that may implement machine code. Microcode typically directly controls hardware circuits of a processor, and is conceptually at a “lower” level than machine code. For example, microcode may interpret machine code.

### Multiplexing Vector Compare Instruction—Example Implementation and Processing

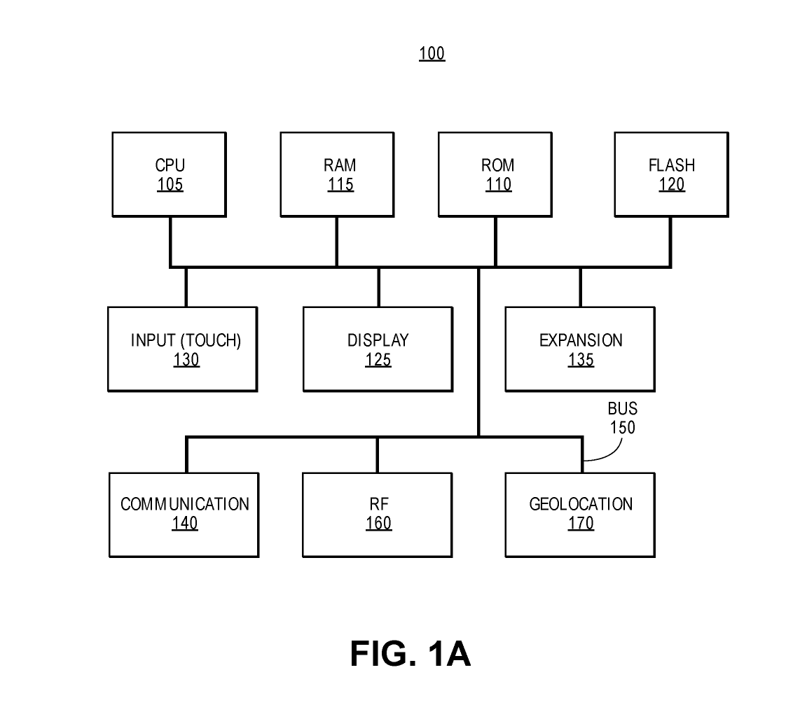

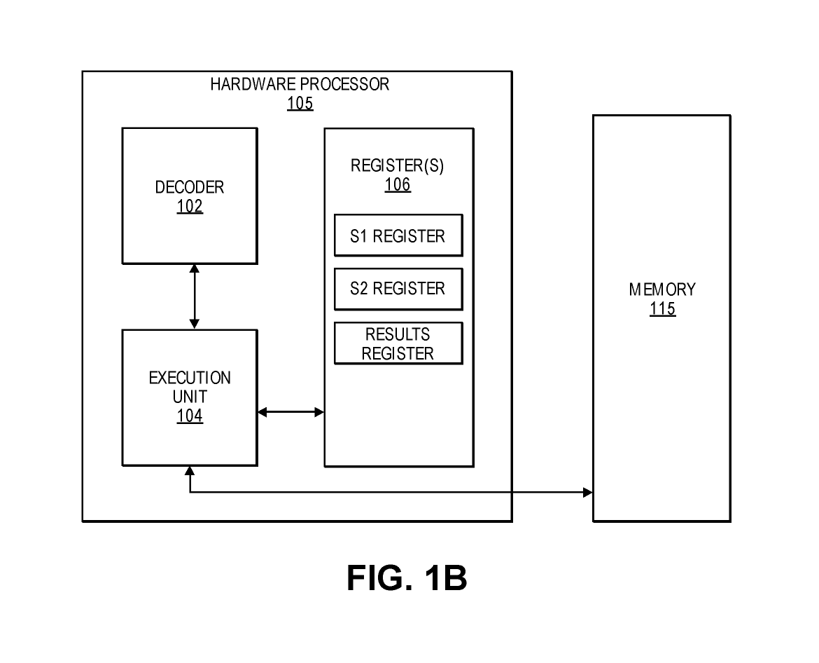

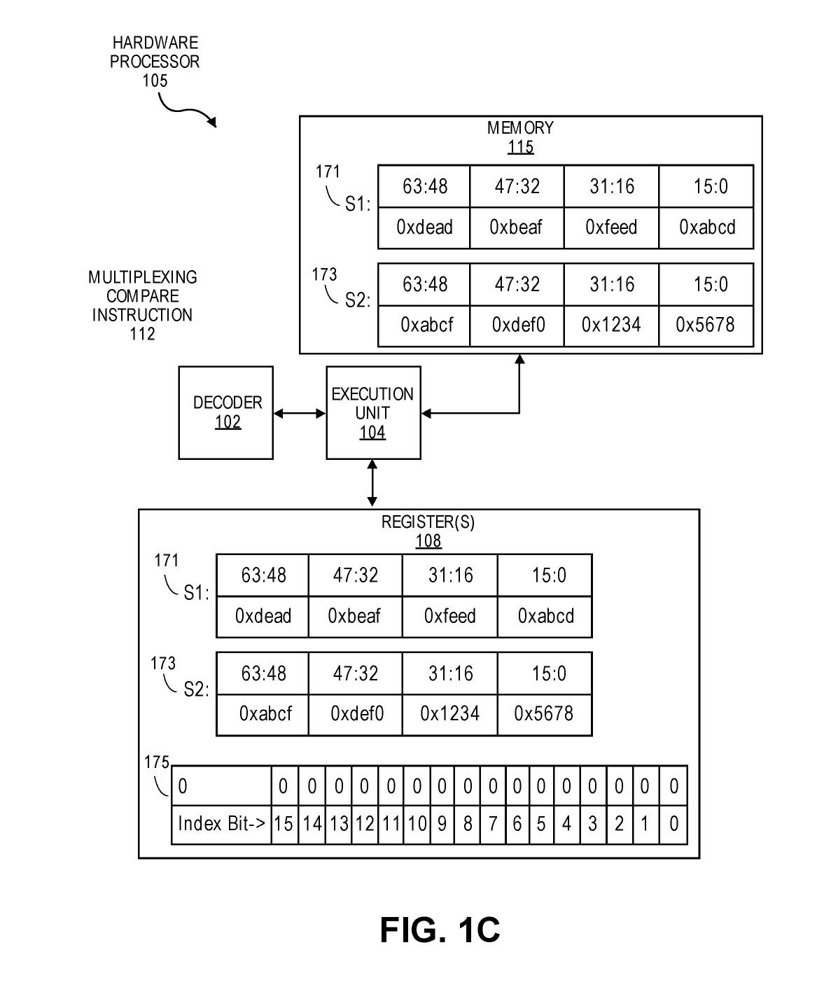

FIG. 1A illustrates an example block diagram of an example computing or electronic system 100, which may be used as a platform to implement the embodiments. The electronic system 100 broadly represents any single or multi-processor computing device or system capable of executing computer or machine-readable instructions. Examples of electronic systems 100 include, without limitation, workstations, laptops, client-side terminals, servers, supercomputers, distributed computing systems, handheld devices, or any other computing system or device. In its most basic configuration, the electronic system 100 may include at least one processor and a system memory. The electronic system 100 may be battery-powered, in some embodiments. The electronic system 100 may be a “server” computer system, in some embodiments. The electronic system 100 may include a desktop or generally “fixed location” computer system, in some embodiments. The electronic system 100 may include a portable computer system, e.g., a “smart” phone. The electronic system 100 may include a “wearable” computer system, e.g., a “smart” watch or an “eye-glasses-mounted” computer system.

The electronic system 100 includes an address/data bus 150 for communicating information and a processor 105, e.g., a central processor or central processing unit (CPU) 105 functionally and communicatively coupled with the bus 150 for processing information and instructions. The processor 105 may include a single processor or multiple processors, e.g., a multi-core processor, or multiple separate processors, in some embodiments. In further embodiments, the central processor may be any type or configuration of processing device capable of executing instructions and the processes described herein. The processor 105 may include branch-prediction functions, in some embodiments. The electronic system 100 may also include a volatile memory 115 (e.g., random access memory RAM) coupled with the bus 150 for storing information and instructions for the processor 105, and may include a non-volatile memory 110 (e.g., read only memory ROM) coupled with the bus 150 for storing static information and instructions for the processor 105.

The processor 105 may be a multi-core processor and may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. The processor 105 may include cores that are coupled to cache control that is associated with a bus interface unit and L2 cache to communicate with other parts of system 100. The bus 105 can be any type of interconnect, which includes an on-chip interconnect, such as an IOSF, AMBA, or other interconnect. The processor 105 and interconnect 105 implement one or more aspects of the described embodiments.

The electronic system 100 also optionally includes a changeable, non-volatile memory 120 (e.g., flash, electronically erasable programmable read only memory EEPROM or similar component) for storing information and instructions for the processor 105 which can be updated after the manufacture of electronic system 100. In some embodiments, only one of the ROM 110 or Flash 120 may be present. In further embodiments, any combination of volatile and non-volatile memory components may be present in the electronic system 100 including any number of separate volatile and non-volatile memory components.

In some embodiments, included in the electronic system 100 is a set of input devices 130. A ‘set,’ as used herein refers to any positive whole number of items including one item. The input device 130 can communicate information and command selections to the processor 100. The input device 130 may be any suitable device for communicating information and/or commands to the electronic system 100. For example, the input device 130 may take the form of a keyboard, buttons, a joystick, a track ball, an audio transducer, e.g., a microphone, a touch sensitive digitizer panel, eyeball scanner, and/or similar components capable of user interaction and/or input generation. A touch sensitive digitizer panel may include any suitable technology, e.g., capacitive, resistive, optical, acoustic and/or pressure responsive touch panels. Activation of a “touch” sensitive digitizer panel may not require actual physical touching of the panel 130 or the electronic system 100, in some embodiments. For example, capacitive touch panels may sense proximity of a user's finger or an eyeball scanner (e.g., in the form of a photo detection device, charged coupled device or similar component) may detect a direction of a user's gaze.

The display unit 125 utilized with the electronic system 100 may include a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic visual images and/or alphanumeric characters recognizable to the user. The display unit 125 may have an associated lighting device, in some embodiments. The display unit 125 may include a head-mounted display, in some embodiments.

The touch sensitive digitizer panel 130, if present, can be associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

The electronic system 100 also optionally includes an expansion interface 135 coupled with the bus 150. Expansion interface 135 can implement many well-known standard expansion interfaces, including without limitation the Secure Digital Card interface, Universal Serial Bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or similar communication mediums. In some embodiments, the expansion interface 135 may include signals substantially compliant with the signals of bus 150.

A wide variety of well-known devices may be attached to the electronic system 100 via the bus 150 and/or expansion interface 135. Examples of such devices include without limitation rotating magnetic memory devices, flash memory devices, digital cameras, wireless communication modules, digital audio players, biometric monitors and/or Global Positioning System (GPS) devices.

The electronic system 100 also optionally includes a communication port 140. The communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

Electronic system 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may include additional software and/or hardware features (not shown) in some embodiments.

Various components of system 100 may access computer or machine-readable media, and the term is known or understood to include removable media, for example, USB (“thumb”) drives, Secure Digital (“SD”) cards, CD, DVD and/or Blu-Ray™ discs, diskettes, tape, and the like, as well as non-removable or internal media, for example, hard drives, RAM, ROM, flash, and the like. Computer or machine-readable media may also store microcode, in some embodiments.

The electronic system 100 may include one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. The electronic system 100 may also determine its position via a mobile telephone network, for example, identifying, measuring signal strength, and/or triangulation of cell towers. The electronic system 100 may also determine its position from known locations of wireless networks, e.g., WiFi hotspots, from an internet protocol (IP) address, or any other applicable location service(s). Geolocation determining features 170 may include dedicated hardware, or may utilize components with one or more other uses.

In some embodiments, the processor 105 may be in communication with other components of the electronic system 100 via a chipset. The chipset may facilitate communication between a set of processors and other components of the system including separate buses that may be utilized for processor and memory communication and other components, respectively. The electronic system 100 can have any combination of architectural components, including caches, busses, peripheral components and processors. The chipset may provide integrated graphics processing. In other embodiments, graphics processing may be provided as separate components in communication with the processors 105 and bus 150 to drive the display 125. The example of electronic system 100 is provided by way of illustration and not limitation.

FIG. 1B is a diagram of one embodiment of an example processor for execution of multiplexing vector compare instructions. In one embodiment, the processor 105 can include a decoder 102, execution unit 104 and a set of registers 106. The processor 105 is in communication via an interconnect with a memory 115. The hardware processor 100 includes a hardware decoder 102 (e.g., decode unit) and a hardware execution unit 104. The hardware processor 100 includes register(s) 106. Registers 106 may include one or more registers to perform operations in, e.g., additionally or alternatively to access of (e.g., load or store) data in memory 110. Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain embodiments herein.

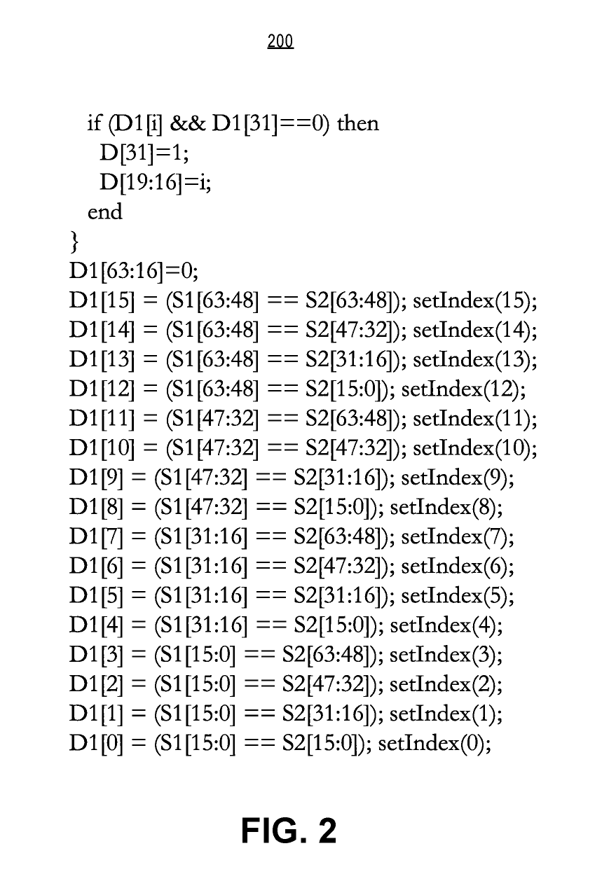

Hardware decoder 102 may receive an (e.g., single) instruction (e.g., macro-instruction) and decode the instruction, e.g., into micro-instructions and/or micro-operations. Hardware execution unit 104 may execute the decoded instruction (e.g., macro-instruction) to perform an operation or operations. An instruction to be decoded by decoder 102 and for the decoded instruction to be executed by execution unit 104 may be any instruction discussed herein, e.g., in reference to FIGS. 2-11. Certain embodiments herein may provide for a blend and compare instruction. Certain embodiments herein may provide for a blend instruction. Certain embodiments herein may provide for a compare instruction.

In certain embodiments, an operation is to perform multiplexing vector compares. Examples of the operations are described in further detail with reference to FIGS. 2-11.

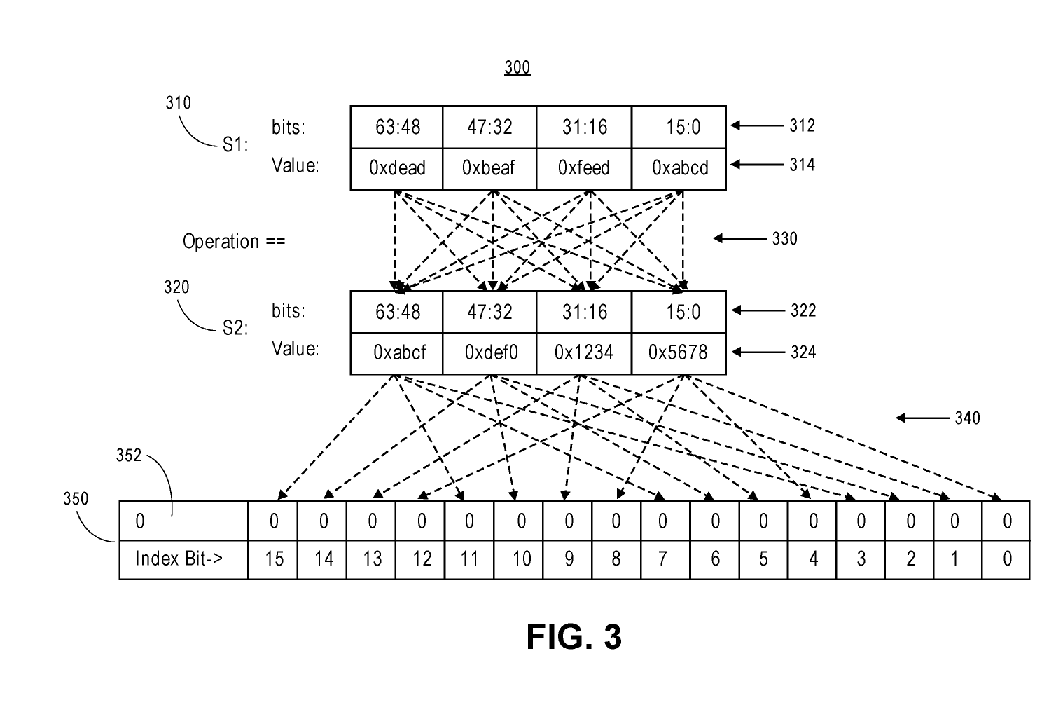

FIG. 1C is a diagram of one embodiment of a processor executing an example multiplexing vector compare instruction. The hardware processor 105 is configured to decode and execute the multiplexing vector compare instruction which compares the vector portions of the input vectors to one another. The output is placed in a third vector. The comparison is effected through a dynamic set of logical gates as a single operation. The instruction 112 (e.g., single instruction) may be decoded (e.g., into micro-instructions and/or micro-operations) by decode unit 102 and the decoded instruction may be executed by the execution unit 104. Data may be accessed in register(s) 108 and/or memory 115. In certain embodiments, the multiplexing vector compare instructions may compare additional vectors, in any case as the instruction is executed, it causes the output to be placed in the destination vector 114 as a result of the operation on the input vectors, e.g., from input operands of the two input vectors. The diagram illustrates an example set of input vectors and values S1, S2, which are described in further detail with relation to FIG. 3 herein below.

FIG. 2 is a diagram of one embodiment of example pseudo code 200 that illustrates operation of a multiplex vector compare. The single equals sign “=” represents a basic assignment operation. The “&&” represents an operator that is a logical “AND.” The double equals sign “==” represents a comparison. The notation “V[x:y]” represents a bit range, e.g., denoting consecutive bits from bit x to bit y, of the vector V. The result is true if the vectors are equal. The pseudo code 200 performs sixteen 16-bit comparisons between portions of vectors S1 and S2, and sets a corresponding bit of an Index vector D1 to “1” if the 16 bits are identical.

The pseudo code of FIG. 2 is illustrative of the function and results of an example multiplex vector compare operation, depicted in multiple lines of a high-level pseudo code. The pseudo code of FIG. 2 however does not necessarily illustrate an embodiment of an example multiplex vector compare operation.

FIG. 3 is a diagram of one embodiment of an example multiplexing vector compare operation 300. Multiplexing vector compare operation 300 illustrates a comparison in which there are no matches.

Multiplexing vector compare operation 300 compares each 16-bit aligned portion, e.g., 2-octets, of vector S1 310 with each 16-bit aligned portion of vector S2 320. Vectors S1 310 and S2 320 are 64 bits long. It is appreciated that the sizes of the vector and vector portion(s) are illustrative, and non-limiting, and that the embodiments are well suited to different vector and vector portion sizes. For example, a multiplexing vector compare may compare all 8-bit or all 32-bit aligned patterns between two 64-bit vectors. In addition, the embodiments are illustrated as performing comparisons of octet-aligned patterns, e.g., aligned to 2-octet boundaries. However, the embodiments are not limited to any specific alignment(s).

Reference numeral 312 indicates the bit numbers of vector S1 310, in 2-octet groupings, e.g., bits 63-48, 47-32, etc. Reference numeral 314 indicates the bit values of vector S1 310. The notation “0x” indicates hexadecimal notation. Similarly, reference numeral 322 indicates the bit numbers of vector 320 S1, in 2-octet groupings. Reference numeral 324 indicates the bit values of vector S320.

The dotted lines 330 indicate the comparisons of each 2-octet aligned portion of vector S1 310 with each 2-octet aligned portion of vector S2 320. For example, bits 15:0 of vector S1 310 are compared with bits 15:0 of vector S2 320. Bits 15:0 of vector S1 310 are also compared to bits 31:16, 47:32, and 63:48 of vector S2 320. Similarly, bits 31:16 of vector S1 310 are compared with each 2-octet aligned portion of vector S2 320.

Reference numeral 340 indicates the propagation of results of the comparisons to results vector 350. In the example embodiment of FIG. 3, vector 350 comprises 16 bits, one bit for each comparison 330. For example, a zero in a bit position of results vector 350 indicates no match for a particular 2-octet comparison. An additional bit 352 may be used to summarize the results of all comparisons. For example, the value of bit 352 may include the logical OR of all bit values in results vector 350. Bit 352 may include an “extra” bit associated with a register, e.g., a carry bit, a sign bit, an overflow flag, and/or the like, in some embodiments.

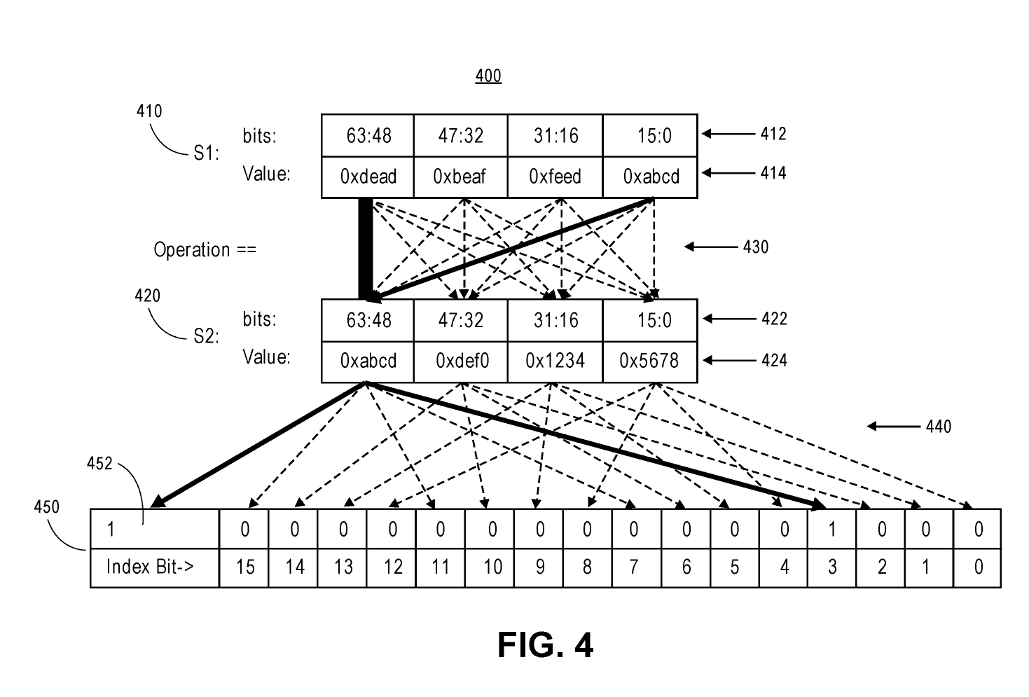

FIG. 4 is a diagram of one embodiment of an example multiplexing vector compare operation 400. Multiplexing vector compare operation 400 illustrates a comparison in which there is one match.

Multiplexing vector compare operation 400 compares each 16-bit aligned portion, e.g., 2-octets, of vector S1 410 with each 16-bit aligned portion of vector 420 S2. Vectors S1 410 and 420 S2 are 64 bits long. It is to be appreciated that the sizes of the vector and vector portion are illustrative, and that embodiments are well suited to different vector and vector portion sizes. In addition, the embodiments are illustrated as performing comparisons of octet-aligned patterns, e.g., aligned to 2-octet boundaries. However, the embodiments are not limited to any specific alignment(s).

Reference numeral 412 indicates the bit numbers of vector S1 410, in 2-octet groupings, e.g., bits 63-48, 47-32, etc. Reference numeral 414 indicates the bit values of vector S1 410. The notation “0x” indicates hexadecimal notation. Similarly, reference numeral 422 indicates the bit numbers of vector S1 410, in 2-octet groupings. Reference numeral 424 indicates the bit values of vector 420 S2.

The lines 430 indicate the comparisons of each 2-octet aligned portion of vector S1 410 with each 2-octet aligned portion of vector 420 S2. For example, bits 15:0 of vector S1 410 are compared with bits 15:0 of vector 420 S2. Bits 15:0 of vector S1 410 are also compared to bits 31:16, 47:32, and 63:48 of vector 420 S2. Similarly, bits 31:16 of vector S1 410 are compared with each 2-octet aligned portion of vector 420 S2. Each dotted line of 430 indicates no match. The solid line of 430, from bits 15:0 of vector S1 410 to bits 63:48 of vector 420 S2, indicates a match. For example, both 16-bit portions of the respective vectors contain the value “0xabcd.”

Reference numeral 440 indicates the propagation of results of the comparisons to results vector 450. In the example embodiment of FIG. 4, vector 450 comprises 16 bits, one bit for each comparison 430. For example, a zero in a bit position of results vector 450 indicates no match for a particular 2-octet comparison. It is appreciated that bit 3 of results vector 450 is “1,” indicating a match on the fourth comparison, e.g., a match of bits 15:0 of vector S1 410 to bits 63:48 of vector 420 S2. An additional bit 452 may be used to summarize the results of all comparisons. For example, the value of bit 452 may be the logical OR of all bit values in results vector 450. In the present example, the value of bit 452 is “1,” indicating at least one match in comparison operation 400.

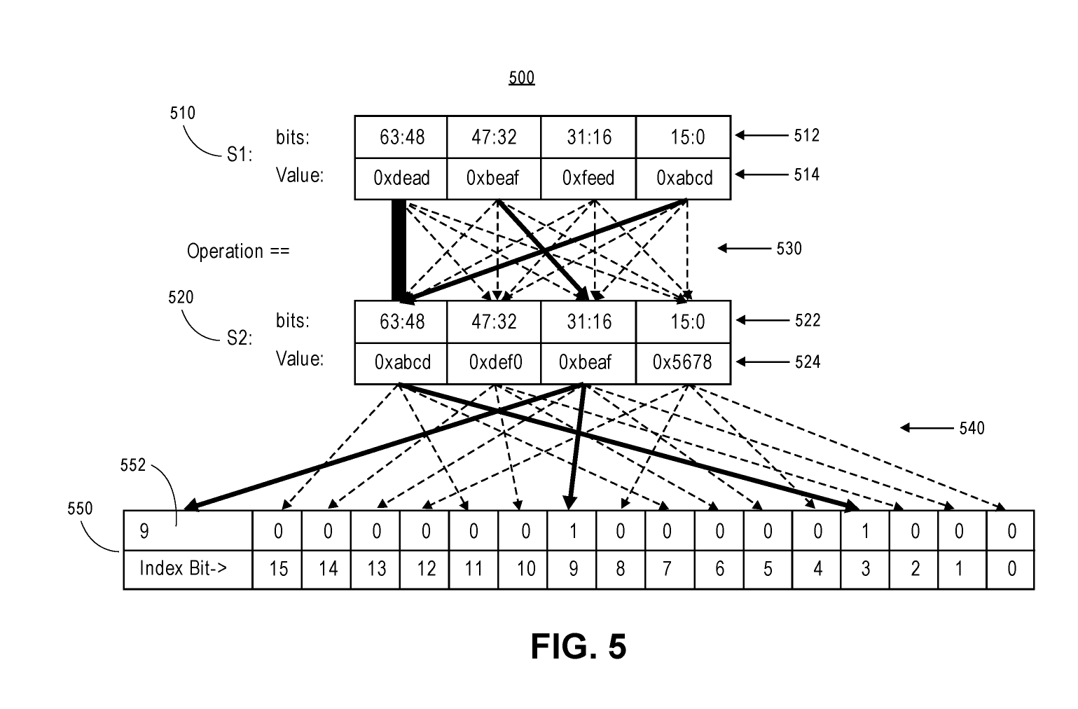

FIG. 5 is a diagram of one embodiment of an example multiplexing vector compare operation 500. Multiplexing vector compare operation 500 illustrates a comparison in which there are multiple matches.

Multiplexing vector compare operation 500 compares each 16-bit aligned portion, e.g., 2-octets, of vector S1 510 with each 16-bit aligned portion of vector S2 520. Vectors S1 510 and S2 520 are 64 bits long. It is to be appreciated that the sizes of the vector and vector portion are illustrative, and that embodiments are well suited to different vector and vector portion sizes. In addition, embodiments are illustrated as performing comparisons of octet-aligned patterns, e.g., aligned to 2-octet boundaries. However, the embodiments are not limited to any specific alignment(s).

Reference numeral 512 indicates the bit numbers of vector S1 510, in 2-octet groupings, e.g., bits 63-48, 47-32, etc. Reference numeral 514 indicates the bit values of vector S1 510. The notation “0x” indicates hexadecimal notation. Similarly, reference numeral 522 indicates the bit numbers of vector S1 510, in 2-octet groupings. Reference numeral 524 indicates the bit values of vector S2 520.

The lines 530 indicate the comparisons of each 2-octet aligned portion of vector S1 510 with each 2-octet aligned portion of vector S2 520. For example, bits 15:0 of vector S1 510 are compared with bits 15:0 of vector S2 520. Bits 15:0 of vector S1 510 are also compared to bits 31:16, 47:32, and 63:48 of vector S2 520. Similarly, bits 31:16 of vector S1 510 are compared with each 2-octet aligned portion of vector S2 520. Each dotted line of 530 indicates no match. The solid lines of 530, from bits 15:0 of vector S1 510 to bits 63:48 of vector S2 520, and from bits 47:32 of vector S1 510 to bits 31:16 of vector S2 520, indicate matches.

Reference numeral 540 indicates the propagation of results of the comparisons to results vector 550. In the example embodiment of FIG. 5, vector 550 comprises 16 bits, one bit for each comparison 530. For example, a zero in a bit position of results vector 550 indicates no match for a particular 2-octet comparison. It is appreciated that bit 3 and bit 9 of results vector 550 are “1,” indicating matches on the fourth and tenth comparisons, e.g., matches of bits 15:0 of vector S1 510 to bits 63:48 of vector S2 520, and of bits 47:32 of vector S1 510 to bits 31:16 of vector S2 520. An additional field 552 may be used to summarize the results of all comparisons. Differing from bits 352 (FIG. 3) and 452 (FIG. 4), field 552 indicates the location of the “highest” match, e.g., corresponding to bit position 9. Field 552 may indicate the “lowest” match, e.g., corresponding to bit position 3, in some embodiments.

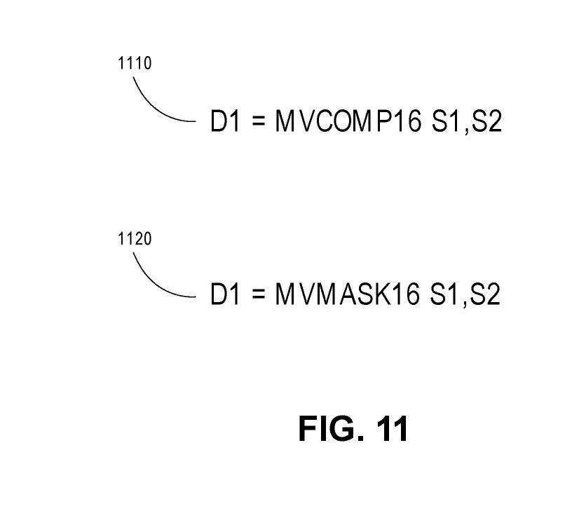

In accordance with the embodiments, multiplexing vector compare operations 300, 400, and/or 500 may be invoked via a single machine language instruction. FIG. 11 illustrates one embodiment of an example assembly language mnemonic 1110 of a single machine language instruction to implement a multiplexing vector compare operation.

D1=MVCOMP16S1,S2

where D1 is the result vector, e.g., results vector 550 of FIG. 5, S1 and S2 are the vectors to be compared, e.g., vector S1 510 and S2 520 of FIG. 5, and “MVCOMP16” is the assembly language mnemonic for a 16-bit multiplexing vector compare instruction. For example, the example “MVCOMP16” instruction compares each 16-bit aligned portion of S1 with each 16-bit aligned portion of S2, as previously illustrated in FIGS. 2, 3, 4 and 5.

The multiplexing vector compare instruction comprises an operation code (“opcode”) and two operands. The multiplexing vector compare instruction may optionally specify a results register, e.g., result vector 350 of FIG. 3, or a default location for the comparison results may be specified by the instruction definition, in some embodiments.

In accordance with one embodiments, a multiplexing vector compare instruction may be implemented in specialized combinatorial hardware. For example, with reference to FIG. 3, the comparisons 330 may be performed by sixteen 16-bit wide comparators functioning in parallel, in some embodiments. A lesser number of comparators may be used in a sequence, e.g., controlled by microcode and/or a state machine, in some embodiments. Wider or narrower comparators may be used in some embodiments. Features of a programming architecture may be used to implement a multiplexing vector compare instruction, in some embodiments. For example, microcode and/or a state machine may sequence a conventional compare instruction, e.g., including rotating and/or shifting register contents, to implement a multiplexing vector compare instruction, in some embodiments.

It is to be appreciated that the embodiments may advantageously bypass much of a processor's instruction processing overhead. For example, under the conventional art, implementation of a multiplexing vector comparison would typically require multiple levels of nested loops of if-then (else) statements, which each further expand into numerous machine language instructions. Each of such machine language instructions is typically pre-fetched into a cache, fetched into an instruction pipeline, and the potential branches are predicted, possibly initiating speculative execution based on such predictions. It is appreciated that this process takes place for each machine-language-level instruction that is executed within the nested loops of the program flow. These iterative implementations suffer from the repeated overhead of dealing with a large number of instructions. It is further appreciated that branch mispredictions are highly detrimental, forcing, for example, roll backs of speculative execution and flushing of instruction pipelines.

When implemented as a single machine-code-level instruction, the embodiments do not suffer the high overhead costs of processing multiple machine language instructions. Further, such a specialized instruction may avoid branch prediction and/or speculative execution processes. For example, the embodiments may not trigger a branch prediction and/or speculative execution process(es), in some embodiments. The embodiments may command a branch prediction and/or speculative execution process to be bypassed and/or suspended, in some embodiments. Accordingly, the embodiments implement a multiplexing vector comparison more efficiently than an iterative looping process and the attendant overhead.

The embodiments are well suited to some of the processes of translating a program in a first binary machine code of a first instruction set to a second binary machine code of a second, different, instruction set. For example, such a translation of binary instructions generally requires a lookup of an opcode from the first instruction set to find a corresponding opcode in the second instruction set. This lookup can be time consuming as the load, bit extract, compare, select from a lookup table, and store operations are sequentially dependent without much opportunity for parallelization. This process may be optimized by running the translation processes in parallel, but still suffers from attempting to match M opcode patterns of the first instruction set to N opcode patterns of the second instruction set, and converting them to patterns of the second architecture. Thus, for each instruction, there is a worst-case M×N comparisons.

In accordance with the embodiments, a multiplexing vector compare operation simplifies and greatly accelerates such a binary translation process. The embodiments reduce the worst-case number of discrete comparisons by up to a factor of 64, and also enable the binary translation process to be parallelized over multiple instructions. The multiplexing vector compare operation takes two operands. A first operand is a portion, e.g., a vector, of binary code in a first, e.g., target, machine language. A second operand is a portion, e.g., a vector, of an opcode correspondence table. For example, an opcode correspondence table lists some set of opcodes from the first instruction set in correspondence to their equivalent opcodes in the second instruction set. The second instruction set may be the native instruction set of the processor performing the translation, but that is not required. Finding a target opcode in the correspondence table identifies an equivalent opcode in the native instruction set. Table 1, below, illustrates a portion of an example opcode correspondence table, in accordance with the embodiments:

TABLE 1

| Target Opcode (binary) “S2” | Corresponding Native Opcode |
|---|---|
| 0x5678 | 0x2345 |
| 0xbeaf | 0xabcf |
| 0xdef0 | 0xbeef |
| 0xabcd | 0x |

The left column of Table 1, “Target Opcode,” lists opcodes of the target instruction set. With reference to FIG. 5, in an example embodiment, a portion of a target program is represented by vector S1 510. Vector S1 510 is compared to the left column of Table 1, e.g., vector S2 520. If a match is found, then the same row of the right column of Table 1 indicates a corresponding opcode in the native, or second, instruction set. This allows binary translation software to quickly query if any number of equivalences is found and which one since the bit pattern is determined by the ordering of the first and second argument. An additional results field, e.g., additional result field 552 of FIG. 5, may also be set to quickly determine if any pattern match was detected. For example, the results vector 550 indicates with row(s) of the correspondence table represent an opcode match, and may be used to determine an offset into a correspondence table to retrieve a corresponding opcode in the second instruction set.

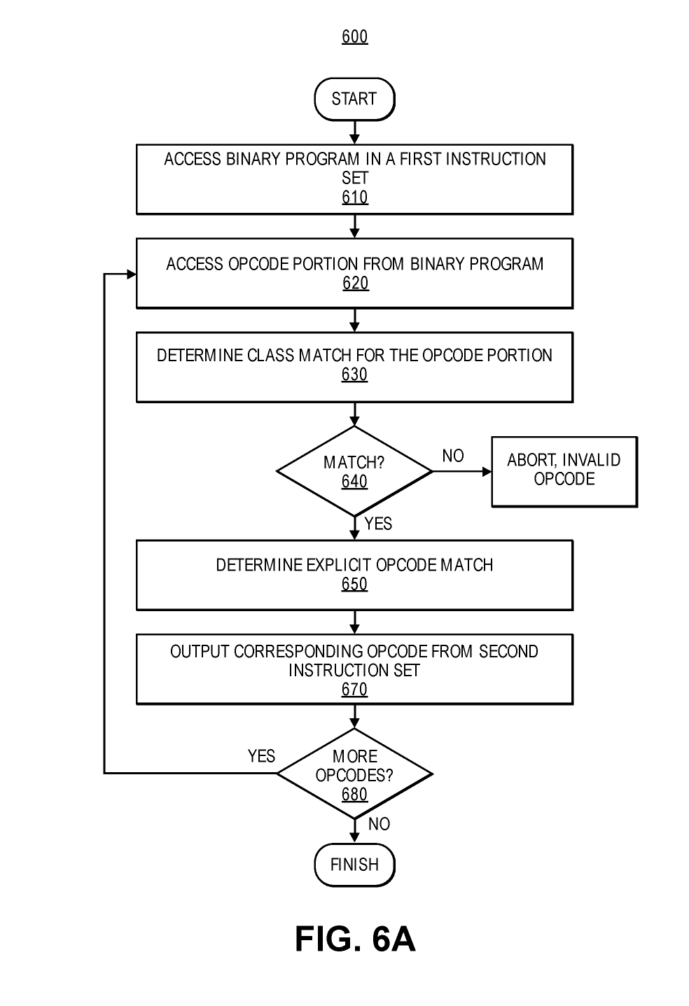

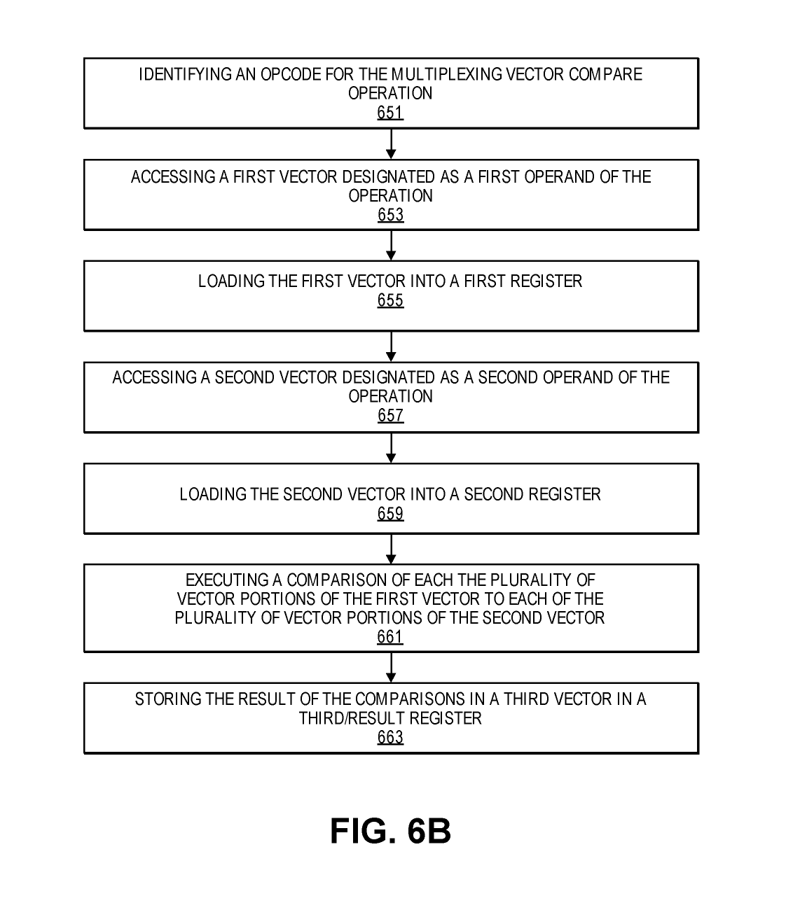

FIG. 6A is a flowchart of one embodiment of an example computer-implemented method 600, in accordance with embodiments. In Block 610, a binary machine language program in a first instruction set is accessed. In Block 620, a portion of the machine language program is accessed. For example, 64-bits of the machine language program are loaded into vector S1 510 of FIG. 5. The machine language program portion may be limited to opcodes, e.g., the portion does not include operands, or portions of opcodes, in some embodiments. In Block 630, a class match for the portion of the machine language program is determined. For example, a multiplexing vector compare operation, e.g., multiplexing vector compare operation 500 of FIG. 5, is performed, for example, with vector S2 520 representing a portion of an opcode correspondence table, e.g., as illustrated in Table 1, above.

In Block 640, the comparison results are checked to determine if a valid opcode was matched. For example, the additional results field 452 of FIG. 4 may be tested for a non-zero value. If no match was found, the segment did not contain a valid opcode, and execution, e.g., of this portion of the program, terminates. If a match was found, processing continues at Block 650. In Block 650, an explicit opcode match is determined. For example, Block 630 may determine a class of opcodes, e.g., all registers from register loads. The operation of Block 650 may determine a specific opcode, e.g., load register A from register B.

In Block 670, the opcode from the second instruction set that corresponds to the opcode from the first instruction set is output to a file that will eventually include a translated program. For example, the opcode from the second instruction set may be determined from an opcode correspondence table, e.g., Table 1, above, as previously described. In 680, execution continues to Block 620 if there are more opcodes to be processed. Otherwise, the process finishes.

FIG. 6B is a diagram of one embodiment of a process for executing a multiplexing vector compare operation. The process may be initiated after the process of FIG. 6A identifies that the operation is the multiplexing vector compare operation. The process may be initiated by the process of FIG. 6A identifying the opcode for the multiplexing vector compare operation (Block 651). The processor may include circuitry as described further herein below to execute the multiplexing compare operation by execution of the single machine language operation corresponding to the opcode of the multiplexing vector compare operation.

The execution of the multiplexing compare causes the accessing of the first vector designated as an operand of the operation (Block 653). This operand may already be in a first register upon which the operation can be executed or may be loaded into a first register that is specific to the execution of the operation as it is tied to the circuitry for the execution of the operation (Block 655). The process may also access a second vector designated as a second operand of the operation (Block 657). This operand may already be in a second register upon which the operation can be executed as it is tied to the operation circuitry. The operand can also be loaded into a second register that is tied to the circuitry for execution of the operation (Block 659). Once the first and second vector are in the first and second registers, the operation performs a comparison of each of the plurality of vector portions of the first vector to each of the plurality of vector portions of the second vector (Block 661). This comparison is facilitated by circuitry such as arrays of XNOR and AND gates or similar logical gates coupled to the registers. The comparision of each vector portion can be bitwise XNOR operation with the output of all bit positions operated over by an AND to determine equality. The result of the comparisons is stored in a result vector as a third vector (Block 663). In some embodiments, the result register location is an operand of the multiplexing vector compare operation. The comparison may also populate a special bit or set of bits in the result vector that indicates an overall result of the operation, a bit location of a result in the result vector or similar addition information as described with relation to the example multiplexor vector compare operations described herein or variations thereof.

### Multiplexing Vector Mask Match Instruction—Example Implementation and Processing

A related operation is known as or referred to as a multiplexing vector mask match operation. A multiplexing vector mask match operation logically ANDS portions, e.g., 16-bits, of a vector against similarly sized portions of a second vector. The second vector may include bit mask patterns, in some embodiments. The multiplexing vector mask match operation may identify specific bit patterns and/or bit locations within the first vector, without requiring that all bits in a portion of a vector, e.g., an aligned 16-bit vector portion, match. For example, the multiplexing vector mask match operation may determine that there is a “1” in the second bit position of a 16-bit vector portion, while treating the other 15 bits as “don't cares.” It is appreciated that the second or mask vector may include any number of “1” bits.

Whereas the previously described example multiplexing vector compare operation compared, for example, each (aligned) 16-bit pattern of a first vector to each (aligned) 16-bit pattern of a second vector for an exact match, e.g., all 16 bits match, a multiplexing vector mask match operation determines if “1” bits occupy certain positions in the first vector.

It should be appreciated that the structures described herein above with relation to the execution of the vector compare instruction can also be utilized in conjunction with the vector mask match instruction. Whereas, the vector compare instruction may be implemented as single instruction via a set of dynamically configured logical gates, the vector mask matching instruction may be implemented as a single instruction via a set of dynamically configured AND gates. One skilled in the art would also appreciate that similar implementations via micro-coding and similar techniques are also within the scope of the embodiments for both instructions.

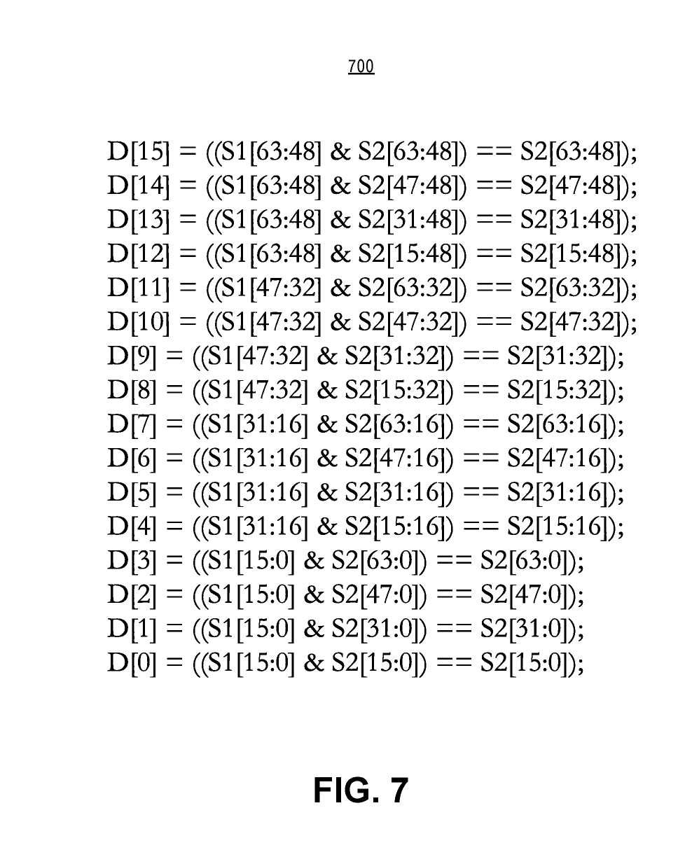

FIG. 7 is a diagram of one embodiment of example pseudo code 700 that illustrates operation of a multiplex vector mask match operation. The single equals sign “=” is basic assignment. The “&” operator is bitwise logical “AND.” The double equals sign “==” is a comparison. The result of an expression is true if the vector portions include “1” bits in the same bit locations. The pseudo code 700 performs sixteen bitwise logical AND operations between portions of vectors S1 and S2, and sets a corresponding bit of an index vector D1 to “1” if the patterns match, e.g., if the portion of the first vector comprises “1” bits in the same locations as the portion of the second vector.

FIG. 7 is diagram of one embodiment of the function and results of an example multiplex vector mask match operation, depicted in multiple lines of a high-level pseudo code. FIG. 7 does not necessarily illustrate an embodiment of an example multiplex vector mask match operation. As can be seen with the pseudo code, at a high level the multiplex vector mask match operation requires a large number of operations and would require an even larger number of equivalent machine language operations/instructions.

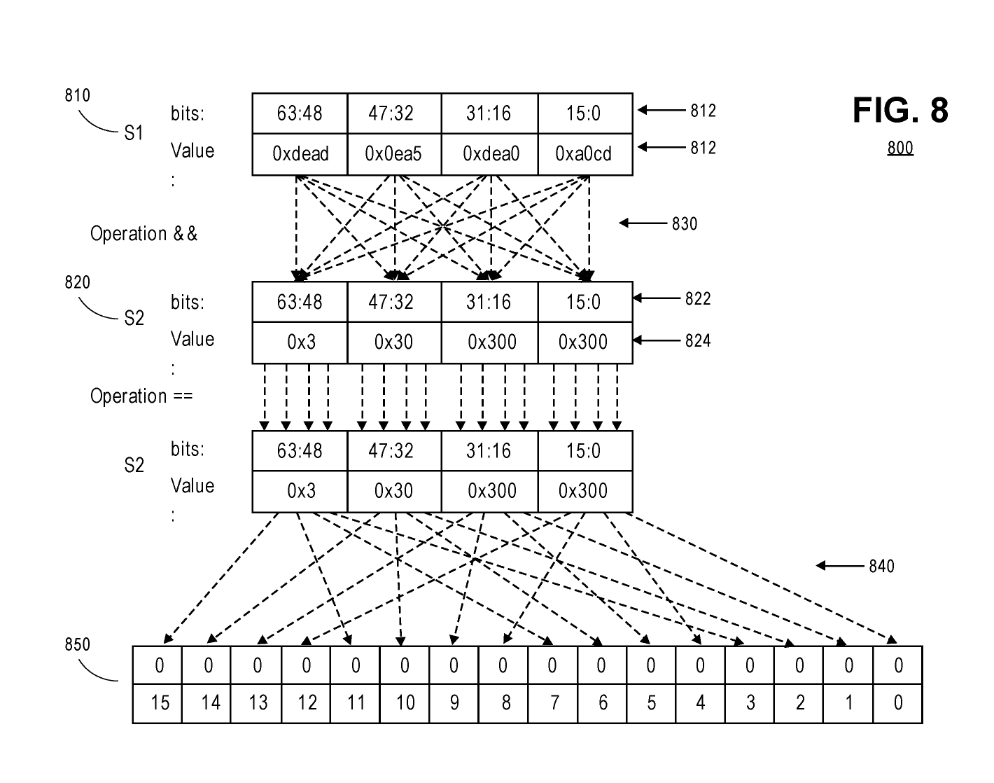

FIG. 8 is a diagram of one embodiment an example multiplex vector mask match operation 800. Multiplexing vector mask match operation 800 illustrates a comparison in which there are no pattern matches.

Multiplexing vector mask match operation 800 performs a bitwise logical AND between the bits of each 16-bit aligned portion, e.g., 2-octets, of vector S1 810 with the bits of each 16-bit aligned portion of vector S2 820. Vectors S1 810 and S2 820 are 64 bits long. It is to be appreciated that the sizes of the vector and vector portion are illustrative, and nonlimiting, and that embodiments are well suited to different vector and vector portion sizes. For example, a multiplexing vector mask match operation may compare all 8-bit or all 32-bit aligned patterns between two 64-bit vectors. In addition, the embodiments are illustrated as performing comparisons of octet-aligned patterns, e.g., aligned to 2-octet boundaries. However, the embodiments are not limited to any specific alignment(s).

Reference numeral 812 indicates the bit numbers of vector S1 810, in 2-octet groupings, e.g., bits 63-48, 47-32, etc. Reference numeral 814 indicates the bit values of vector S1 810. The notation “0x” indicates hexadecimal notation. Similarly, reference numeral 822 indicates the bit numbers of vector 820 S1, in 2-octet groupings. Reference numeral 824 indicates the bit values of vector S2 820.

The dotted lines 830 indicate the bit-wise logical ANDing of each 2-octet aligned portion of vector S1 810 with each 2-octet aligned portion of vector S2 820. For example, bits 15:0 of vector S1 810 are bit-wise logically ANDed with bits 15:0 of vector S2 820. Bits 15:0 of vector S1 810 are also bitwise logically ANDed to bits 31:16, 47:32 and 63:48 of vector S2 820. Similarly, bits 31:16 of vector S1 810 are bit-wise logically ANDed with each 2-octet aligned portion of vector S2 820.

Reference numeral 840 indicates the propagation of results of the bit-wise logical ANDing to results vector 850. In the example embodiment of FIG. 8, vector 850 comprises 16 bits, one bit for each bit-wise logical ANDing 830. For example, a zero in a bit position of results vector 850 indicates no match for a particular 2-octet bit-wise logical ANDing. For example, the patterns 0x3, 0x30, 0x300, and/or 0x3000 do not appear any of the four 16-bit aligned portions of vector S1 810, e.g., the values of vector S1 810 do not contain the hexadecimal digits 3, 7, b, or f, which would match one of the mask patterns 0x3, 0x30, 0x300, or 0x3000 of vector S2 820.

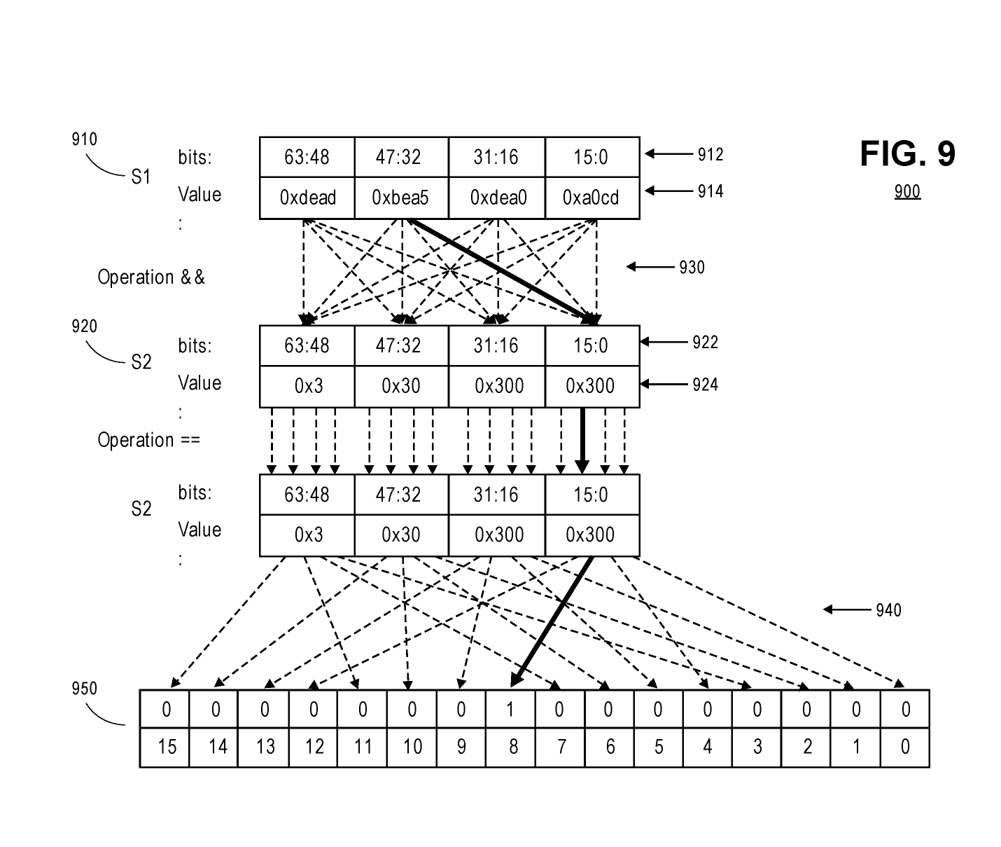

FIG. 9 is a diagram of one embodiment of an example multiplex vector mask match operation 900. Multiplexing vector mask match operation 900 illustrates a comparison in which there is one pattern match.

Multiplexing vector mask match operation 900 performs a bitwise logical AND between the bits of each 16-bit aligned portion, e.g., 2-octets, of vector S1 910 with the bits of each 16-bit aligned portion of vector S2 920. Vectors S1 910 and S2 920 are 64 bits long. It is to be appreciated that the sizes of the vector and vector portion are illustrative, and nonlimiting, and that the embodiments are well suited to different vector and vector portion sizes. For example, a multiplexing vector mask match operation may compare all 8-bit or all 32-bit aligned patterns between two 64-bit vectors. In addition, the embodiments are illustrated as performing comparisons of octet-aligned patterns, e.g., aligned to 2-octet boundaries. However, the embodiments are not limited to any specific alignment(s).

Reference numeral 912 indicates the bit numbers of vector S1 910, in 2-octet groupings, e.g., bits 63-48, 47-32, etc. Reference numeral 914 indicates the bit values of vector S1 910. The notation “0x” indicates hexadecimal notation. Similarly, reference numeral 922 indicates the bit numbers of vector 920 S1, in 2-octet groupings. Reference numeral 924 indicates the bit values of vector S2 920.

The lines 930 indicate the bit-wise logical ANDing of each 2-octet aligned portion of vector S1 910 with each 2-octet aligned portion of vector S2 920. For example, bits 15:0 of vector S1 910 are bit-wise logically ANDed with bits 15:0 of vector S2 920. Bits 15:0 of vector S1 910 are also bitwise logically ANDed to bits 31:16, 47:32 and 63:48 of vector S2 920. Similarly, bits 31:16 of vector S1 910 are bit-wise logically ANDed with each 2-octet aligned portion of vector S2 920. Each dotted line of 930 indicates no pattern match. The solid line in 930 indicates a pattern match. For example, vector S1 910 bits 47:32 include the pattern 0xbea5. The character “b” in the bits 47:44 matches the pattern 0x3000 in bits 15:0 of vector S2 920. For example, the lowest order two bits of the hexadecimal number 0xb match the lowest order two bits of the hexadecimal number 0x3.

Reference numeral 940 indicates the propagation of results of the bit-wise logical ANDing to results vector 950. In the example embodiment of FIG. 9, vector 950 comprises 16 bits, one bit for each bit-wise logical ANDing 930. For example, a zero in a bit position of results vector 950 indicates no match for a particular 2-octet bit-wise logical ANDing. In the example embodiment of FIG. 9, the pattern 0x3000 (bits 15:0 of S2 920) appears in bits 47:32 of vector S1 910, and hence bit 8 of results vector 950 is set to “1.”

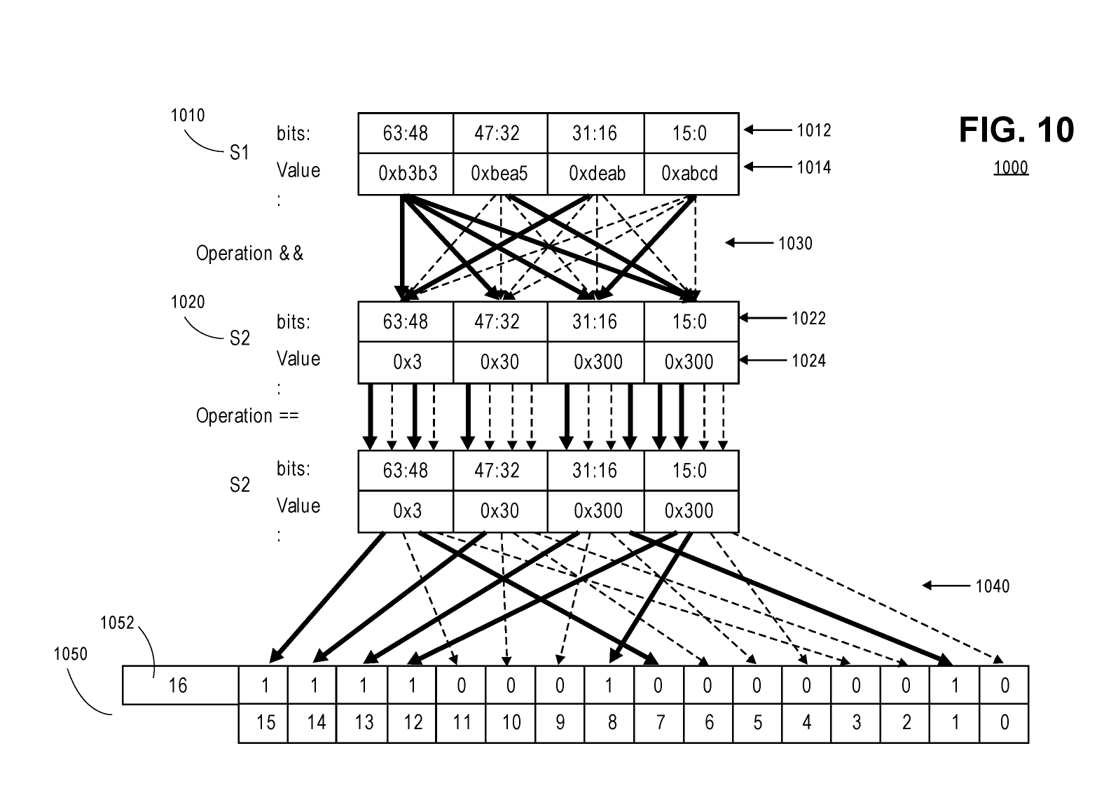

FIG. 10 is a diagram of one embodiment of an example multiplex vector mask match operation 1000. Multiplexing vector mask match operation 1000 illustrates a comparison in which there are multiple pattern matches.

Multiplexing vector mask match operation 1000 performs a bitwise logical AND between the bits of each 16-bit aligned portion, e.g., 2-octets, of vector S1 1010 with the bits of each 16-bit aligned portion of vector S2 1020. Vectors S1 1010 and S2 1020 are 64 bits long. It is to be appreciated that the sizes of the vector and vector portion are illustrative, and non-limiting, and that embodiments are well suited to different vector and vector portion sizes. For example, a multiplexing vector mask match operation may compare all 8-bit or all 32-bit aligned patterns between two 64-bit vectors. In addition, the embodiments are illustrated as performing comparisons of octet-aligned patterns, e.g., aligned to 2-octet boundaries. The embodiments are not limited to any specific alignment(s).

Reference numeral 1012 indicates the bit numbers of vector S1 1010, in 2-octet groupings, e.g., bits 63-48, 47-32, etc. Reference numeral 1014 indicates the bit values of vector S1 1010. The notation “0x” indicates hexadecimal notation. Similarly, reference numeral 1022 indicates the bit numbers of vector 1020 S1, in 2-octet groupings. Reference numeral 1024 indicates the bit values of vector S2 1020.

The lines 1030 indicate the bit-wise logical ANDing of each 2-octet aligned portion of vector S1 1010 with each 2-octet aligned portion of vector S2 1020. For example, bits 15:0 of vector S1 1010 are bit-wise logically ANDed with bits 15:0 of vector S2 1020. Bits 15:0 of vector S1 1010 are also bit-wise logically ANDed to bits 31:16, 47:32 and 63:48 of vector S2 1020. Similarly, bits 31:16 of vector S1 1010 are bit-wise logically ANDed with each 2-octet aligned portion of vector S2 1020. Each dotted line of 1030 indicates no pattern match. The solid lines in 1030 indicate a pattern match. For example, vector S1 1010 bits 47:32 include the pattern 0xbea5. The character “b” in the bits 47:44 matches the pattern 0x3000 in bits 15:0 of vector S2 1020. For example, the lowest order two bits of the hexadecimal number 0xb match the lowest order two bits of the hexadecimal number 0x3.

Reference numeral 1040 indicates the propagation of results of the bitwise logical ANDing to results vector 1050. In the example embodiment of FIG. 10, vector 1050 comprises 16 bits, one bit for each bit-wise logical ANDing 1030. For example, a zero in a bit position of results vector 1050 indicates no match for a particular 2-octet bit-wise logical ANDing. In the example embodiment of FIG. 10, there are seven pattern matches. For example, the pattern 0xb3b3 in S2 1010 bits 63:48 comprises ones in the lower order two bits of each nibble, and thus matches each of the mask patterns 0x3, 0x30, 0x300, and 0x3000 of vector S2 81020. Similarly, the pattern 0xabcd in S2 1010 bits 15:0 has ones in the lower order two bits of the third nibble, and thus matches mask pattern 0x300 of bits 31:16 of vector S2 1020. As indicated in results vector 1050, there are seven pattern matches illustrated in the embodiment of FIG. 10. An additional field 1052 may be used to summarize the results of all comparisons, in some embodiments. Field 1052 indicate may the location of the “highest” match plus one, e.g., corresponding to bit position 15, in a manner similar to field 552 of FIG. 5. The addition of one to the bit location enables the presence of a non-zero value in field 1052 to indicate a pattern match. Field 1052 may indicate the “lowest” match, in some embodiments. Multiplexing vector mask match operation 800, 900, and/or 1000 may be invoked via a single machine language instruction.

FIG. 11 is a diagram of one embodiment of an example assembly language mnemonic 1110 of a single machine language instruction to implement a multiplexing comparison operation.

D1=MVCOMP16S1,S2

where D1 is the result vector, e.g., results vector 550 of FIG. 5, S1 and S2 are the vectors to be compared, e.g., vector S1 510 and S2 520 of FIG. 5, and “MVCOMP16 ” is the assembly language mnemonic for a 16-bit multiplexing vector comparison instruction. For example, the example “MVCOMP16” instruction bit-wise logically XNORs and then ANDs each 16-bit aligned portion of S1 with each 16-bit aligned portion of S2, as previously illustrated in FIGS. 2, 3, 4 and 5.

The multiplexing vector comparison instruction comprises an operation code (“opcode”) and two operands. The multiplexing vector comparison instruction may optionally specify a results register, e.g., result vector 550 of FIG. 5, or a default location for the comparison results may be specified by the instruction definition, in some embodiments.

A multiplexing vector comparison instruction may be implemented in specialized combinatorial hardware. For example, with reference to FIG. 5, the comparisons 530 may be performed by 256 (16 bits wide×16 comparisons) 2-input XNOR gates functioning substantially in parallel with a second level of AND, in some embodiments. A lesser number of XNOR and AND gates may be used in a sequence, e.g., controlled by microcode and/or a state machine, in some embodiments. Wider XNOR AND gates may be used in some embodiments. Other logical gate implementations may be used that are equivalent and/or provide the requisite comparision. Features of a programming architecture may be used to implement a multiplexing vector mask match instruction, in some embodiments. For example, microcode and/or a state machine may sequence a conventional bitwise XNOR and/or AND instruction, e.g., including rotating and/or shifting register contents, to implement a multiplexing vector comparison instruction, in some embodiments. It is to be appreciated that embodiments may advantageously bypass much of a processor's instruction processing overhead. For example, absent the embodiments, implementation of a multiplexing vector comparison would typically require multiple levels of nested loops of in-then (else) statements, which each further expand into numerous machine language instructions. Each of such machine language instructions is typically pre-fetched into a cache, fetched into an instruction pipeline, and the potential branches are predicted, possibly initiating speculative execution based on such predictions. It is appreciated that this process takes place for each machine-language-level instruction that is executed within the nested loops of the program flow. The conventional art implementation suffers from the repeated overhead of dealing with a large number of instructions. It is further appreciated that branch mispredictions are highly detrimental, forcing, for example, roll backs of speculative execution and flushing of instruction pipelines.

When implemented as a single machine-code-level instruction, the embodiments do not suffer the high overhead costs of processing multiple machine language instructions. Further, such a specialized instruction may avoid branch prediction and/or speculative execution processes. For example, embodiments may not trigger a branch prediction and/or speculative execution process(es), in some embodiments. Embodiments may command a branch prediction and/or speculative execution process to be bypassed and/or suspended, in some embodiments. Accordingly, the embodiments implement a multiplexing vector comparison more efficiently than under the conventional art.

Referring once again to FIG. 6A, the above described multiplexing comparison instruction is well-suited to operation in Block 650 of method 600. For example, once a class of opcodes in the first instruction set has been determined, a multiplexing vector comparison instruction may be utilized to determine an explicit opcode match, e.g., the exact opcode from among a class of opcodes. For example, the value loaded into vector portion S2 520, and S3 536 of FIG. 5 may be one or more actual opcodes from the first instruction set.

Embodiments provide methods and systems for performing multiplexing vector comparisons. In addition, embodiments provide methods and systems for performing multiplexing comparisons in a single machine language instruction. Further, the embodiments provide methods and systems for performing multiplexing vector comparisons that eliminate the overhead of branch predictions. Still further, the embodiments provide methods and systems for performing multiplexing vector comparison that are compatible and complementary with existing systems and methods of processor design, programming, and operation.

The multiplexing vector comparison has been described in a general computing environment, herein above. However, one skilled in the art would understand that the multiplexing vector comparison instruction may be a part of an instruction set and implemented in any instruction set architecture (ISA). Example instructions sets and instructions set architectures consistent with the embodiments of the multiplexing vector comparison are disclosed herein below.

### EXAMPLE EMBODIMENTS

In one embodiment, a computer-implemented method for multiplexing vector matching includes accessing a first vector having a vector length, wherein the first vector includes a plurality of vector portions of a vector portion length, accessing a second vector having the vector length, wherein the second vector includes a same quantity of vector portions as the plurality of vector portions, and wherein the vector portions of the second vector are of the vector portion length, comparing each of the plurality of vector portions of the first vector to each of the plurality of vector portions of the second vector, and storing a result of the comparison in a third vector with at least one bit of the third vector corresponds to the comparison of the first plurality of vector portions and the second plurality of vector portions.

In some embodiments, the computer-implemented method operates such that each of the plurality of vector portions is aligned on a boundary of the vector portion length, the vector length is 64 bits, and/or the vector portion length is 16 bits. The computer-implemented method may operate such that the third vector includes a field that indicates if there were any matches resulting from the comparison. The computer-implemented method may operate such the field indicates a position within the third vector of a match indication and the accessing the first vector, the accessing the second vector, the comparison, and the storing the results is performed by a single machine language instruction.

In some embodiments, a processor includes at least one core including circuitry configured to perform a multiplexing vector comparison operation responsive to execution of one machine language instruction, and at least one register to receive a result vector from the multiplexing vector comparison operation. In further embodiments, the processor may be configured to, responsive to execution of the one machine language instruction, execute the multiplexing vector comparison operation by loading a first vector into a first register, the first vector having a vector length, wherein the first vector includes a plurality of vector portions having a vector portion length, loading a second vector of the vector length into a second register, wherein the second vector includes the same quantity of vector portions as the plurality of vector portions, and wherein the vector portions of the second vector are of the vector portion length, executing a comparison of each of the plurality of vector portions of the first vector in the first register to each of the plurality of vector portions of the second vector in the second register, and storing a result vector in a third register with at least one bit of the result vector corresponding to each combination of the plurality of vector portions from the first vector and second vector, without executing a second machine language instruction.

In some embodiments, the processor further includes circuitry configured to control a sequence of comparisons required by the multiplexing vector comparison operation. The processor may be further configured to not perform any branch prediction in conjunction with the execution of the one machine language instruction. The processor may be further configured to not perform any speculative execution in conjunction with the execution of the one machine language instruction. The processor may be configured such that the multiplexing vector compare operation performs a bit-wise logical XNOR of each bit of each two-octet aligned portion of a first 64-bit register of the computer processor with each bit of each two-octet aligned portion of a second 64-bit register of the processor and then performs a logical AND on the results of each XNOR.

In one embodiment, a machine-readable medium has instructions stored therein which, when executed, cause a processor to perform a set of operations. The set of operations include loading a first vector having a vector length, wherein the first vector includes a plurality of vector portions of a vector portion length, loading a second vector having the vector length, wherein the second vector includes a same quantity of vector portions as the plurality of vector portions, and wherein the vector portions of the second vector are of the vector portion length, performing a comparison of each of the plurality of vector portions of the first vector to each bit of each of the plurality of vector portions of the second vector, and storing a result of the performing in a third vector with at least one bit of the third vector corresponds to each of the bit-wise logical AND of vector portions.

In some embodiments, the machine-readable medium includes instructions such that the operations are invoked in their entirety by a single machine language instruction. The machine-readable medium may include instructions such that the operations further specifically exclude branch prediction during performance of the operations, and/or the operations further specifically exclude speculative execution within performance of the operations. In some embodiments, the instructions of the machine-readable medium are such that the comparison is performed in parallel or the vector portions are aligned on boundaries of the vector portion length.

In one embodiment, a computing device includes a memory to store data and instructions, an interconnect to communicatively couple the memory and a processor, and the processor configured to include first circuitry to access a first vector having a vector length, wherein the first vector comprises a plurality of vector portions having a vector portion length, second circuitry to access a second vector of the vector length, wherein the second vector comprises a same quantity of vector portions as the plurality of vector portions, and wherein the vector portions of the second vector are of the vector portion length, third circuitry to perform a comparison of each of the plurality of vector portions of the first vector to each of the plurality of vector portions of the second vector, and fourth circuitry to store a result of the comparisons in a third vector with at least one bit of the third vector corresponding to each of the comparison of the pluralities of the first and the second vector portions, wherein the first, second, third and fourth circuitry are to perform all of their functions responsive to execution of one machine language instruction by the processor.

In some embodiments, the computing device is configured such that the third circuitry is to perform all the comparisons in parallel or the third circuitry further includes sequencing circuitry configured to control a sequence of the bitwise logical XNOR and AND operations. The computing device may be configured such that the sequencing circuitry includes microcode. The computing device may be configured such that the sequencing circuitry includes a state machine. The processor may further be configured to not perform any branch prediction in conjunction with the operation, and/or to not perform any speculative execution in conjunction with the operation.

### Instruction Sets

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

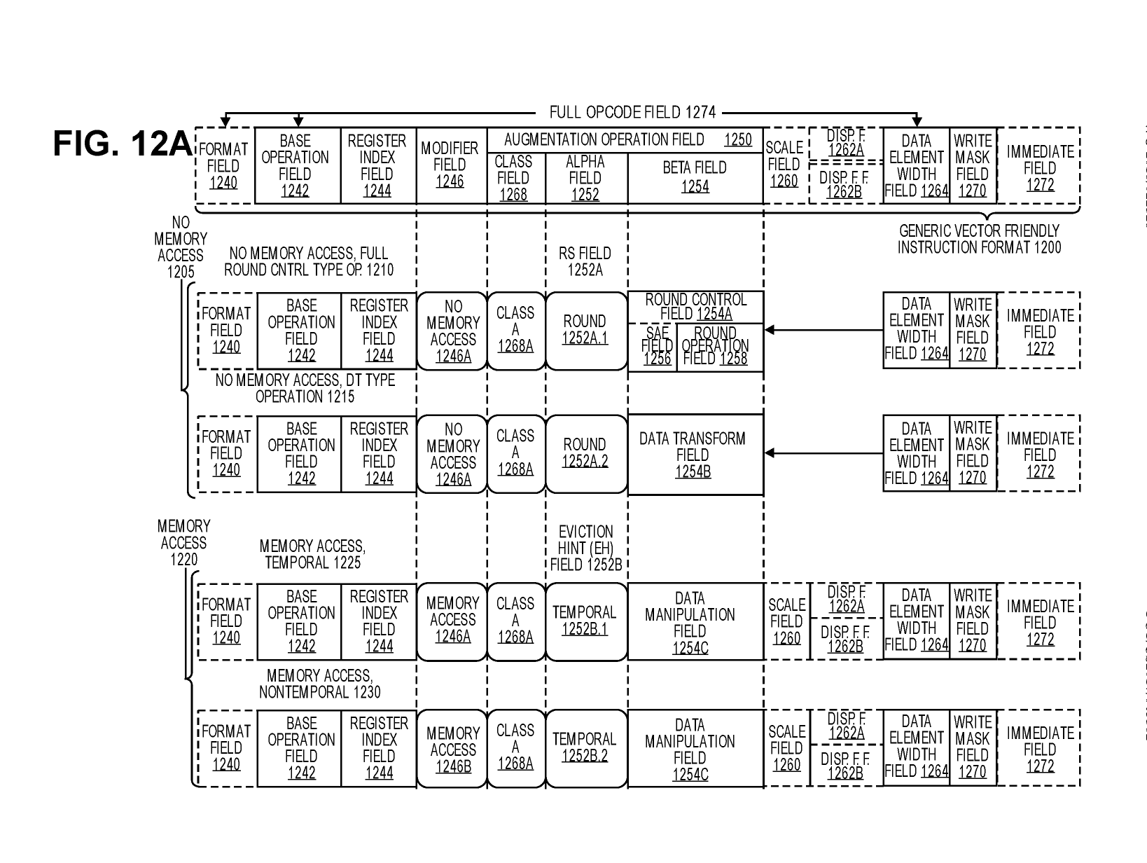

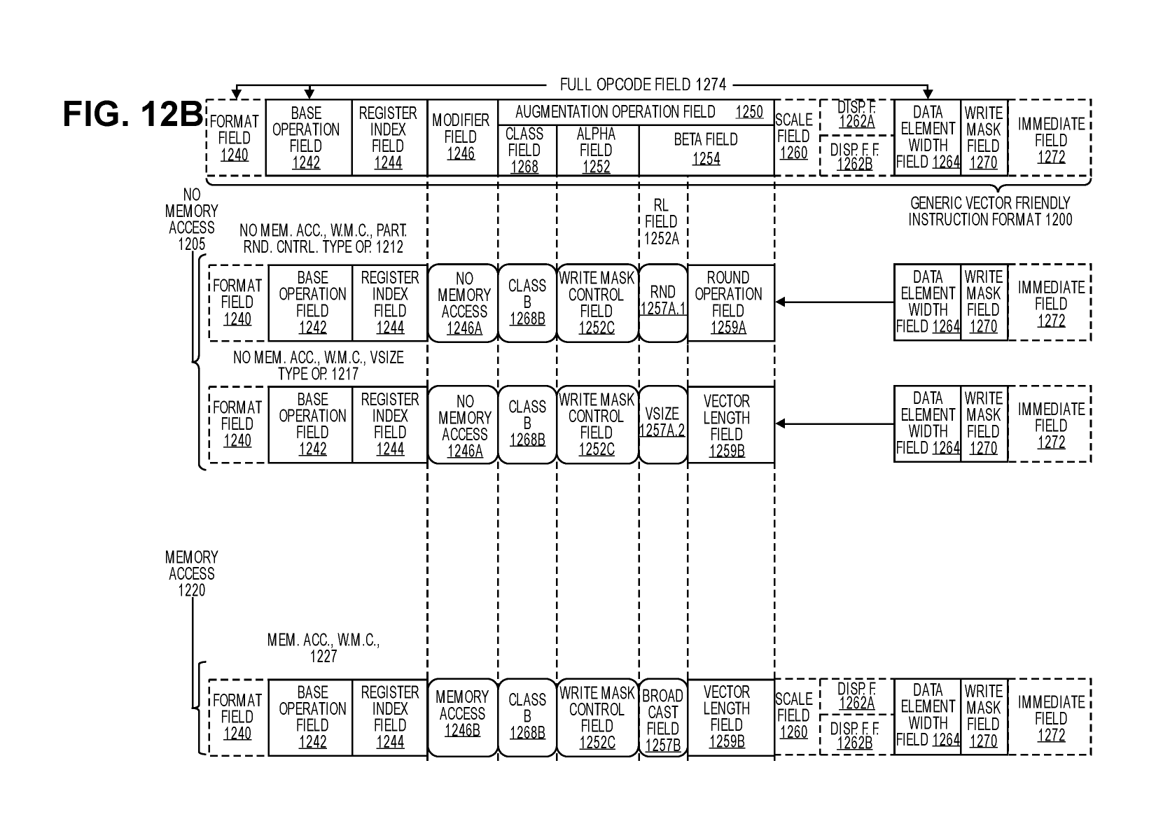

FIGS. 12A-12B are block diagrams illustrating a generic vector friendly instruction format and instruction templates thereof according to embodiments of the invention. FIG. 12A is a block diagram illustrating a generic vector friendly instruction format and class A instruction templates thereof according to embodiments of the invention; while FIG. 12B is a block diagram illustrating the generic vector friendly instruction format and class B instruction templates thereof according to embodiments of the invention. Specifically, a generic vector friendly instruction format 1200 for which are defined class A and class B instruction templates, both of which include no memory access 1205 instruction templates and memory access 1220 instruction templates. The term generic in the context of the vector friendly instruction format refers to the instruction format not being tied to any specific instruction set.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 12A include: 1) within the no memory access 1205 instruction templates there is shown a no memory access, full round control type operation 1210 instruction template and a no memory access, data transform type operation 1215 instruction template; and 2) within the memory access 1220 instruction templates there is shown a memory access, temporal 1225 instruction template and a memory access, non-temporal 1230 instruction template. The class B instruction templates in FIG. 12B include: 1) within the no memory access 1205 instruction templates there is shown a no memory access, write mask control, partial round control type operation 1212 instruction template and a no memory access, write mask control, vsize type operation 1217 instruction template; and 2) within the memory access 1220 instruction templates there is shown a memory access, write mask control 1227 instruction template.

The generic vector friendly instruction format 1200 includes the following fields listed below in the order illustrated in FIGS. 12A-2B.

Format field 1240—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1242—its content distinguishes different base operations.

Register index field 1244—its content, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 1246—its content distinguishes occurrences of instructions in the generic vector instruction format that specify memory access from those that do not; that is, between no memory access 1205 instruction templates and memory access 1220 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 1250—its content distinguishes which one of a variety of different operations to be performed in addition to the base operation. This field is context specific. In one embodiment of the invention, this field is divided into a class field 1268, an alpha field 1252, and a beta field 1254. The augmentation operation field 1250 allows common groups of operations to be performed in a single instruction rather than 2, 3, or 4 instructions.

Scale field 1260—its content allows for the scaling of the index field's content for memory address generation (e.g., for address generation that uses 2^{scale}*index+base).

Displacement Field 1262A—its content is used as part of memory address generation (e.g., for address generation that uses 2^{scale}*index+base+displacement).

Displacement Factor Field 1262B (note that the juxtaposition of displacement field 1262A directly over displacement factor field 1262B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1274 (described later herein) and the data manipulation field 1254C. The displacement field 1262A and the displacement factor field 1262B are optional in the sense that they are not used for the no memory access 1205 instruction templates and/or different embodiments may implement only one or none of the two.

Data element width field 1264—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1270—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1270 allows for partial vector operations, including loads, stores, arithmetic, logical, etc. While embodiments of the invention are described in which the write mask field's 1270 content selects one of a number of write mask registers that contains the write mask to be used (and thus the write mask field's 1270 content indirectly identifies that masking to be performed), alternative embodiments instead or additional allow the mask write field's 1270 content to directly specify the masking to be performed.

Immediate field 1272—its content allows for the specification of an immediate. This field is optional in the sense that is it not present in an implementation of the generic vector friendly format that does not support immediate and it is not present in instructions that do not use an immediate.

Class field 1268—its content distinguishes between different classes of instructions. With reference to FIGS. 12A-B, the contents of this field select between class A and class B instructions. In FIGS. 12A-B, rounded corner squares are used to indicate a specific value is present in a field (e.g., class A 1268A and class B 1268B for the class field 1268 respectively in FIGS. 12A-B).

### Instruction Templates of Class A

In the case of the non-memory access 1205 instruction templates of class A, the alpha field 1252 is interpreted as an RS field 1252A, whose content distinguishes which one of the different augmentation operation types are to be performed (e.g., round 1252A.1 and data transform 1252A.2 are respectively specified for the no memory access, round type operation 1210 and the no memory access, data transform type operation 1215 instruction templates), while the beta field 1254 distinguishes which of the operations of the specified type is to be performed. In the no memory access 1205 instruction templates, the scale field 1260, the displacement field 1262A, and the displacement scale filed 1262B are not present.

### No-Memory Access Instruction Templates—Full Round Control Type Operation

In the no memory access full round control type operation 1210 instruction template, the beta field 1254 is interpreted as a round control field 1254A, whose content(s) provide static rounding. While in the described embodiments of the invention the round control field 1254A includes a suppress all floating point exceptions (SAE) field 1256 and a round operation control field 1258, alternative embodiments may support may encode both these concepts into the same field or only have one or the other of these concepts/fields (e.g., may have only the round operation control field 1258).

SAE field 1256—its content distinguishes whether or not to disable the exception event reporting; when the SAE field's 1256 content indicates suppression is enabled, a given instruction does not report any kind of floating-point exception flag and does not raise any floating point exception handler.

Round operation control field 1258—its content distinguishes which one of a group of rounding operations to perform (e.g., Round-up, Round-down, Round-towards-zero and Round-to-nearest). Thus, the round operation control field 1258 allows for the changing of the rounding mode on a per instruction basis. In one embodiment of the invention where a processor includes a control register for specifying rounding modes, the round operation control field's 1250 content overrides that register value.

### No Memory Access Instruction Templates—Data Transform Type Operation

In the no memory access data transform type operation 1215 instruction template, the beta field 1254 is interpreted as a data transform field 1254B, whose content distinguishes which one of a number of data transforms is to be performed (e.g., no data transform, swizzle, broadcast).

In the case of a memory access 1220 instruction template of class A, the alpha field 1252 is interpreted as an eviction hint field 1252B, whose content distinguishes which one of the eviction hints is to be used (in FIG. 12A, temporal 1252B.1 and non-temporal 1252B.2 are respectively specified for the memory access, temporal 1225 instruction template and the memory access, non-temporal 1230 instruction template), while the beta field 1254 is interpreted as a data manipulation field 1254C, whose content distinguishes which one of a number of data manipulation operations (also known as primitives) is to be performed (e.g., no manipulation; broadcast; up conversion of a source; and down conversion of a destination). The memory access 1220 instruction templates include the scale field 1260, and optionally the displacement field 1262A or the displacement scale field 1262B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 1252 is interpreted as a write mask control (Z) field 1252C, whose content distinguishes whether the write masking controlled by the write mask field 1270 should be a merging or a zeroing.

In the case of the non-memory access 1205 instruction templates of class B, part of the beta field 1254 is interpreted as an RL field 1257A, whose content distinguishes which one of the different augmentation operation types are to be performed (e.g., round 1257A.1 and vector length (VSIZE) 1257A.2 are respectively specified for the no memory access, write mask control, partial round control type operation 1212 instruction template and the no memory access, write mask control, VSIZE type operation 1217 instruction template), while the rest of the beta field 1254 distinguishes which of the operations of the specified type is to be performed. In the no memory access 1205 instruction templates, the scale field 1260, the displacement field 1262A, and the displacement scale filed 1262B are not present.

In the no memory access, write mask control, partial round control type operation 1210 instruction template, the rest of the beta field 1254 is interpreted as a round operation field 1259A and exception event reporting is disabled (a given instruction does not report any kind of floating-point exception flag and does not raise any floating point exception handler).

Round operation control field 1259A—just as round operation control field 1258, its content distinguishes which one of a group of rounding operations to perform (e.g., Round-up, Round-down, Round-towards-zero and Round-to-nearest). Thus, the round operation control field 1259A allows for the changing of the rounding mode on a per instruction basis. In one embodiment of the invention where a processor includes a control register for specifying rounding modes, the round operation control field's 1250 content overrides that register value.

In the no memory access, write mask control, VSIZE type operation 1217 instruction template, the rest of the beta field 1254 is interpreted as a vector length field 1259B, whose content distinguishes which one of a number of data vector lengths is to be performed on (e.g., 128, 256, or 512 byte).

In the case of a memory access 1220 instruction template of class B, part of the beta field 1254 is interpreted as a broadcast field 1257B, whose content distinguishes whether or not the broadcast type data manipulation operation is to be performed, while the rest of the beta field 1254 is interpreted the vector length field 1259B. The memory access 1220 instruction templates include the scale field 1260, and optionally the displacement field 1262A or the displacement scale field 1262B.

With regard to the generic vector friendly instruction format 1200, a full opcode field 1274 is shown including the format field 1240, the base operation field 1242, and the data element width field 1264. While one embodiment is shown where the full opcode field 1274 includes all of these fields, the full opcode field 1274 includes less than all of these fields in embodiments that do not support all of them. The full opcode field 1274 provides the operation code (opcode).

The augmentation operation field 1250, the data element width field 1264, and the write mask field 1270 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the invention, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the invention. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

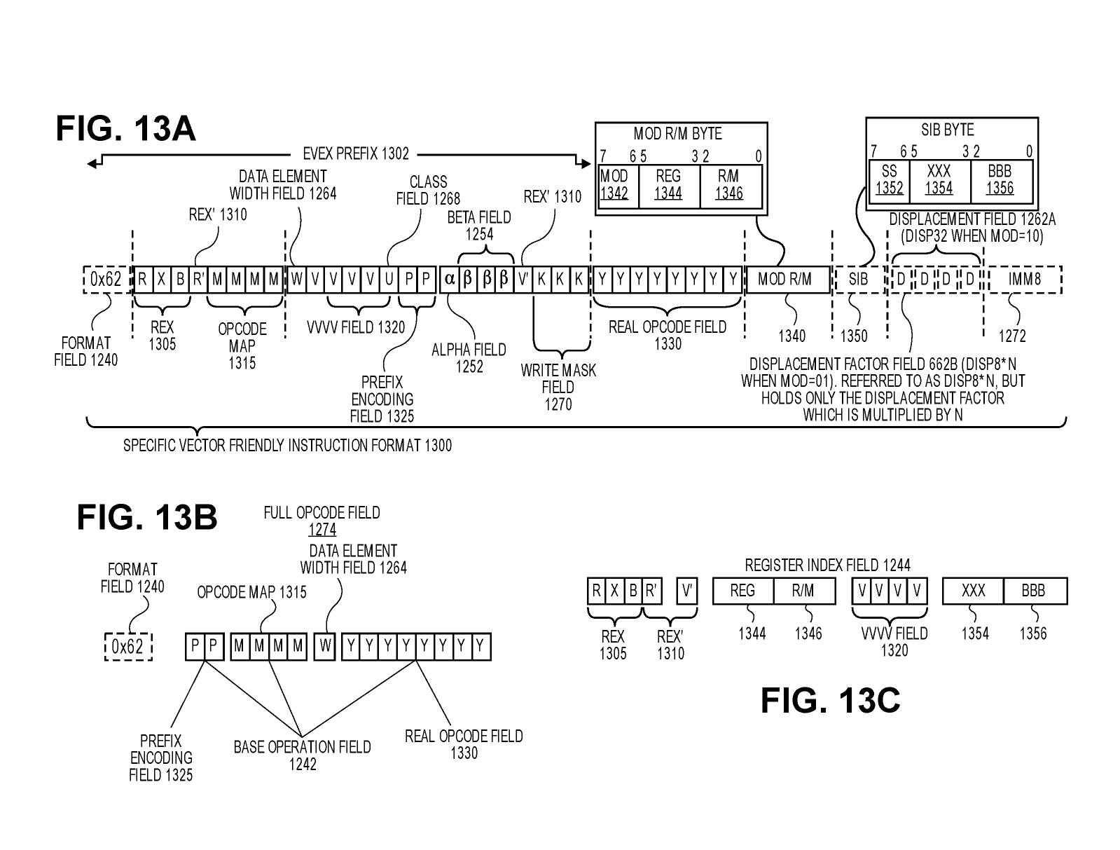

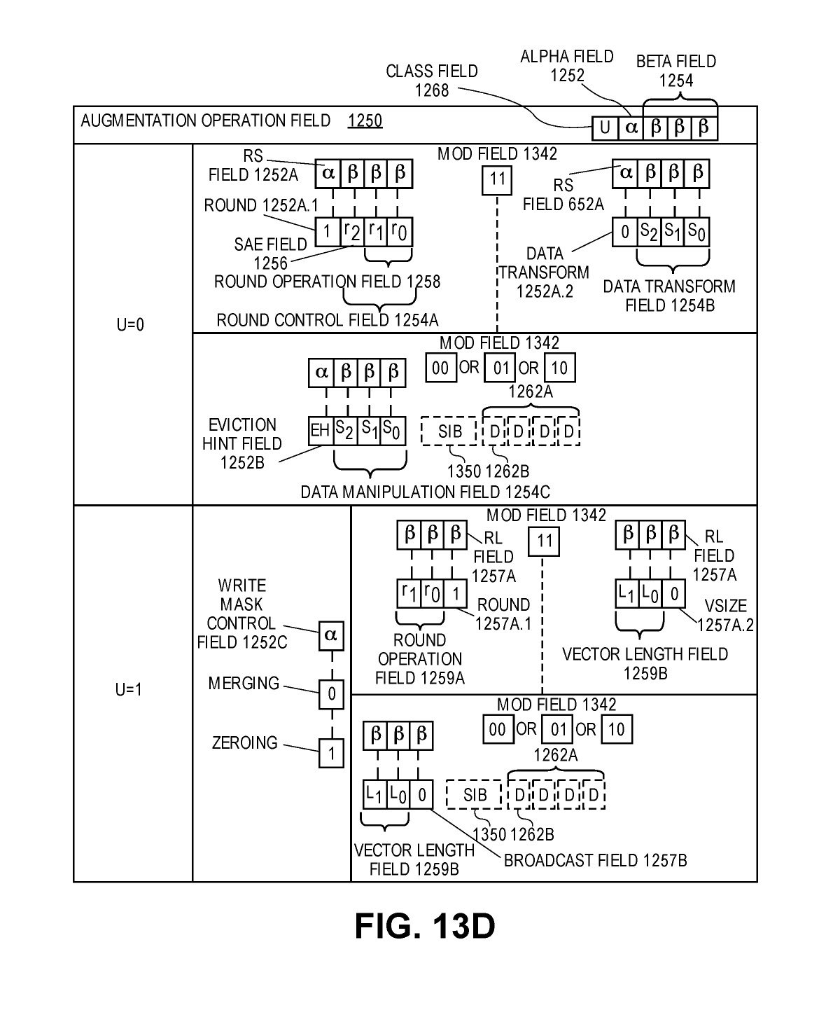

FIG. 13A is a block diagram illustrating an exemplary specific vector friendly instruction format according to embodiments of the invention. FIG. 13A shows a specific vector friendly instruction format 1300 that is specific in the sense that it specifies the location, size, interpretation, and order of the fields, as well as values for some of those fields. The specific vector friendly instruction format 1300 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 12 into which the fields from FIG. 13A map are illustrated.

It should be understood that, although embodiments of the invention are described with reference to the specific vector friendly instruction format 1300 in the context of the generic vector friendly instruction format 1200 for illustrative purposes, the invention is not limited to the specific vector friendly instruction format 1300 except where claimed. For example, the generic vector friendly instruction format 1200 contemplates a variety of possible sizes for the various fields, while the specific vector friendly instruction format 1300 is shown as having fields of specific sizes. By way of specific example, while the data element width field 1264 is illustrated as a one bit field in the specific vector friendly instruction format 1300, the invention is not so limited (that is, the generic vector friendly instruction format 1200 contemplates other sizes of the data element width field 1264).

The generic vector friendly instruction format 1200 includes the following fields listed below in the order illustrated in FIG. 13A.

EVEX Prefix (Bytes 0-3) 1302—is encoded in a four-byte form.

Format Field 1240 (EVEX Byte 0, bits [7:0])—the first byte (EVEX Byte 0) is the format field 1240 and it contains 0x62 (the unique value used for distinguishing the vector friendly instruction format in one embodiment of the invention).

The second-fourth bytes (EVEX Bytes 1-3) include a number of bit fields providing specific capability.

REX field 1305 (EVEX Byte 1, bits [7-5])—consists of a EVEX.R bit field (EVEX Byte 1, bit [7]-R), EVEX.X bit field (EVEX byte 1, bit [6]-X), and 1257BEX byte 1, bit[5]-B). The EVEX.R, EVEX.X, and EVEX.B bit fields provide the same functionality as the corresponding VEX bit fields, and are encoded using is complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1210—this is the first part of the REX′ field 1210 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1315 (EVEX byte 1, bits [3:0]-mmmm)—its content encodes an implied leading opcode byte (0F, 0F, 38, or 0F 3).

Data element width field 1264 (EVEX byte 2, bit [7]-W)—is represented by the notation EVEX.W. EVEX.W is used to define the granularity (size) of the datatype (either 32-bit data elements or 64-bit data elements).

EVEX.vvvv 1320 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in is complement form for certain vector shifts; or 3) EVEX.vvvv does not encode any operand, the field is reserved and should contain 1111b. Thus, EVEX.vvvv field 1320 encodes the 4 low-order bits of the first source register specifier stored in inverted (1s complement) form. Depending on the instruction, an extra different EVEX bit field is used to extend the specifier size to 32 registers.

EVEX.U 1268 Class field (EVEX byte 2, bit [2]-U)—If EVEX.U=0, it indicates class A or EVEX.U0; if EVEX.U=1, it indicates class B or EVEX.U1.

Prefix encoding field 1325 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1252 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 1254 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 1210—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1270 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1330 (Byte 4) is also known as the opcode byte. Part of the opcode is specified in this field.

MOD R/M Field 1340 (Byte 5) includes MOD field 1342, Reg field 1344, and R/M field 1346. As previously described, the MOD field's 1342 content distinguishes between memory access and non-memory access operations. The role of Reg field 1344 can be summarized to two situations: encoding either the destination register operand or a source register operand, or be treated as an opcode extension and not used to encode any instruction operand. The role of R/M field 1346 may include the following: encoding the instruction operand that references a memory address, or encoding either the destination register operand or a source register operand.

Scale, Index, Base (SIB) Byte (Byte 6)—As previously described, the scale field's 1250 content is used for memory address generation. SIB.xxx 1354 and SIB.bbb 1356—the contents of these fields have been previously referred to with regard to the register indexes Xxxx and Bbbb.

Displacement field 1262A (Bytes 7-10)—when MOD field 1342 contains 10, bytes 7-10 are the displacement field 1262A, and it works the same as the legacy 32-bit displacement (disp32) and works at byte granularity.

Displacement factor field 1262B (Byte 7)—when MOD field 1342 contains 01, byte 7 is the displacement factor field 1262B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1262B is a reinterpretation of disp8; when using displacement factor field 1262B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1262B substitutes the legacy x86 instruction set 8-bit displacement. Thus, the displacement factor field 1262B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 1272 operates as previously described.

### Full Opcode Field

FIG. 13B is a block diagram illustrating the fields of the specific vector friendly instruction format 1300 that make up the full opcode field 1274 according to one embodiment of the invention. Specifically, the full opcode field 1274 includes the format field 1240, the base operation field 1242, and the data element width (W) field 1264. The base operation field 1242 includes the prefix encoding field 1325, the opcode map field 1315, and the real opcode field 1330.

### Register Index Field

FIG. 13C is a block diagram illustrating the fields of the specific vector friendly instruction format 1300 that make up the register index field 1244 according to one embodiment of the invention. Specifically, the register index field 1244 includes the REX field 1305, the REX′ field 1310, the MODR/M.reg field 1344, the MODR/M.r/m field 1346, the VVVV field 1320, xxx field 1354, and the bbb field 1356.

### Augmentation Operation Field

FIG. 13D is a block diagram illustrating the fields of the specific vector friendly instruction format 1300 that make up the augmentation operation field 1250 according to one embodiment of the invention. When the class (U) field 1268 contains 0, it signifies EVEX.U0 (class A 1268A); when it contains 1, it signifies EVEX.U1 (class B 1268B). When U=0 and the MOD field 1342 contains 11 (signifying a no memory access operation), the alpha field 1252 (EVEX byte 3, bit [7]-EH) is interpreted as the rs field 1252A. When the rs field 1252A contains a 1 (round 1252A.1), the beta field 1254 (EVEX byte 3, bits [6:4]-SSS) is interpreted as the round control field 1254A. The round control field 1254A includes a one bit SAE field 1256 and a two bit round operation field 1258. When the rs field 1252A contains a 0 (data transform 1252A.2), the beta field 1254 (EVEX byte 3, bits [6:4]-SSS) is interpreted as a three bit data transform field 1254B. When U=0 and the MOD field 1342 contains 00, 01, or 10 (signifying a memory access operation), the alpha field 1252 (EVEX byte 3, bit [7]-EH) is interpreted as the eviction hint (EH) field 1252B and the beta field 1254 (EVEX byte 3, bits [6:4]-SSS) is interpreted as a three bit data manipulation field 1254C.

When U=1, the alpha field 1252 (EVEX byte 3, bit [7]-EH) is interpreted as the write mask control (Z) field 1252C. When U=1 and the MOD field 1342 contains 11 (signifying a no memory access operation), part of the beta field 1254 (EVEX byte 3, bit [4]-S0) is interpreted as the RL field 1257A; when it contains a 1 (round 1257A.1) the rest of the beta field 1254 (EVEX byte 3, bit [6-5]-S2-1) is interpreted as the round operation field 1259A, while when the RL field 1257A contains a 0 (VSIZE 1257.A2) the rest of the beta field 1254 (EVEX byte 3, bit [6-5]-S2-1) is interpreted as the vector length field 1259B (EVEX byte 3, bit [6-5]-L1-0). When U=1 and the MOD field 1342 contains 00, 01, or 10 (signifying a memory access operation), the beta field 1254 (EVEX byte 3, bits [6:4]-SSS) is interpreted as the vector length field 1259B (EVEX byte 3, bit [6-5]-L1-0) and the broadcast field 1257B (EVEX byte 3, bit [4]-B).

### Exemplary Register Architecture

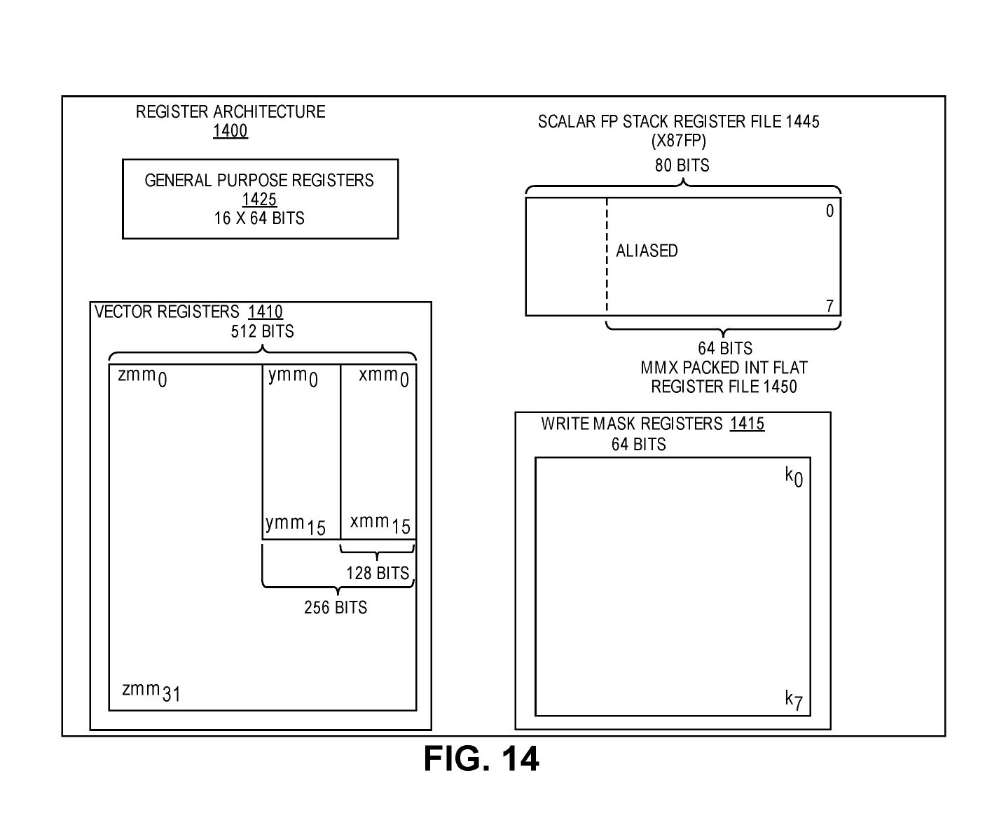

FIG. 14 is a block diagram of a register architecture 1400 according to one embodiment of the invention. In the embodiment illustrated, there are 32 vector registers 1410 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1300 operates on these overlaid register file as illustrated in the below tables.

| Adjustable Vector | | | |
|---|---|---|---|
| Length | Class | Operations | Registers |
| Instruction Templates | A (FIG. | 1210, 1215, | zmm registers |
| that do not include the | 12A; U = 0) | 1225, 1230 | (the vector length |
| vector length field | | | is 64 byte) |
| 1259B | B (FIG. | 1212 | zmm registers |
| | 12B; U = 1) | | (the vector length |
| | | | is 64 byte) |
| Instruction templates | B (FIG. | 1217, 1227 | zmm, ymm, or xmm |
| that do include the | 12B; U = 1) | | registers (the vector |
| vector length field | | | length is 64 byte, |
| 1259B | | | 32 byte, or 16 byte) |
| | | | depending on the |
| | | | vector length field |
| | | | 1259B |

In other words, the vector length field 1259B selects between a maximum length and one or more other shorter lengths, where each such shorter length is half the length of the preceding length; and instructions templates without the vector length field 1259B operate on the maximum vector length. Further, in one embodiment, the class B instruction templates of the specific vector friendly instruction format 1300 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1415—in the embodiment illustrated, there are 8 write mask registers (k0 through k7), each 64 bits in size. In an alternate embodiment, the write mask registers 1415 are 16 bits in size. As previously described, in one embodiment of the invention, the vector mask register k0 cannot be used as a write mask; when the encoding that would normally indicate k0 is used for a write mask, it selects a hardwired write mask of OxFFFF, effectively disabling write masking for that instruction.

General-purpose registers 1425—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1445, on which is aliased the MMX packed integer flat register file 1450—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Block Diagram

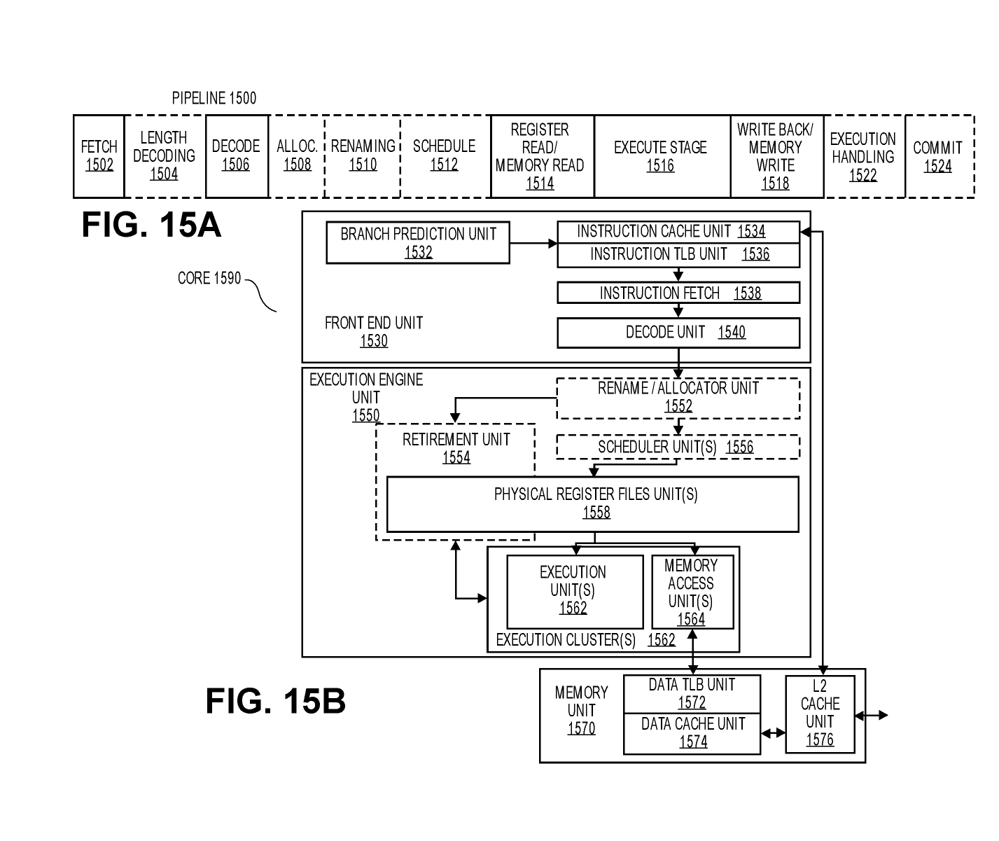

FIG. 15A is a block diagram illustrating both an exemplary in-order pipeline and an exemplary register renaming, out-of-order issue/execution pipeline according to embodiments of the invention. FIG. 15B is a block diagram illustrating both an exemplary embodiment of an in-order architecture core and an exemplary register renaming, out-of-order issue/execution architecture core to be included in a processor according to embodiments of the invention. The solid lined boxes in FIGS. 15A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 15A, a processor pipeline 1500 includes a fetch stage 1502, a length decode stage 1504, a decode stage 1506, an allocation stage 1508, a renaming stage 1510, a scheduling (also known as a dispatch or issue) stage 1512, a register read/memory read stage 1514, an execute stage 1516, a write back/memory write stage 1518, an exception handling stage 1522, and a commit stage 1524.

FIG. 15B shows processor core 1590 including a front end unit 1530 coupled to an execution engine unit 1550, and both are coupled to a memory unit 1570. The core 1590 may be a reduced instruction set computing (RISC) core, a complex instruction set computing (CISC) core, a very long instruction word (VLIW) core, or a hybrid or alternative core type. As yet another option, the core 1590 may be a special-purpose core, such as, for example, a network or communication core, compression engine, coprocessor core, general purpose computing graphics processing unit (GPGPU) core, graphics core, or the like.

The front end unit 1530 includes a branch prediction unit 1532 coupled to an instruction cache unit 1534, which is coupled to an instruction translation lookaside buffer (TLB) 1536, which is coupled to an instruction fetch unit 1538, which is coupled to a decode unit 1540. The decode unit 1540 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1540 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1590 includes a microcode ROM or other medium that stores microcode for certain macroinstructions (e.g., in decode unit 1540 or otherwise within the front end unit 1530). The decode unit 1540 is coupled to a rename/allocator unit 1552 in the execution engine unit 1550.

The execution engine unit 1550 includes the rename/allocator unit 1552 coupled to a retirement unit 1554 and a set of one or more scheduler unit(s) 1556. The scheduler unit(s) 1556 represents any number of different schedulers, including reservations stations, central instruction window, etc. The scheduler unit(s) 1556 is coupled to the physical register file(s) unit(s) 1558. Each of the physical register file(s) units 1558 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1558 comprises a vector registers unit, a write mask registers unit, and a scalar registers unit. These register units may provide architectural vector registers, vector mask registers, and general purpose registers. The physical register file(s) unit(s) 1558 is overlapped by the retirement unit 1554 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1554 and the physical register file(s) unit(s) 1558 are coupled to the execution cluster(s) 1560. The execution cluster(s) 1560 includes a set of one or more execution units 1562 and a set of one or more memory access units 1564. The execution units 1562 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1556, physical register file(s) unit(s) 1558, and execution cluster(s) 1560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1564). It should also be understood that where separate pipelines are used, one or more of these pipelines may be out-of-order issue/execution and the rest in-order.

The set of memory access units 1564 is coupled to the memory unit 1570, which includes a data TLB unit 1572 coupled to a data cache unit 1574 coupled to a level 2 (L2) cache unit 1576. In one exemplary embodiment, the memory access units 1564 may include a load unit, a store address unit, and a store data unit, each of which is coupled to the data TLB unit 1572 in the memory unit 1570. The instruction cache unit 1534 is further coupled to a level 2 (L2) cache unit 1576 in the memory unit 1570. The L2 cache unit 1576 is coupled to one or more other levels of cache and eventually to a main memory.

By way of example, the exemplary register renaming, out-of-order issue/execution core architecture may implement the pipeline 1500 as follows: 1) the instruction fetch 1538 performs the fetch and length decoding stages 1502 and 1504; 2) the decode unit 1540 performs the decode stage 1506; 3) the rename/allocator unit 1552 performs the allocation stage 1508 and renaming stage 1510; 4) the scheduler unit(s) 1556 performs the schedule stage 1512; 5) the physical register file(s) unit(s) 1558 and the memory unit 1570 perform the register read/memory read stage 1514; the execution cluster 1560 perform the execute stage 1516; 6) the memory unit 1570 and the physical register file(s) unit(s) 1558 perform the write back/memory write stage 1518; 7) various units may be involved in the exception handling stage 1522; and 8) the retirement unit 1554 and the physical register file(s) unit(s) 1558 perform the commit stage 1524.

The core 1590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1590 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1534/1574 and a shared L2 cache unit 1576, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

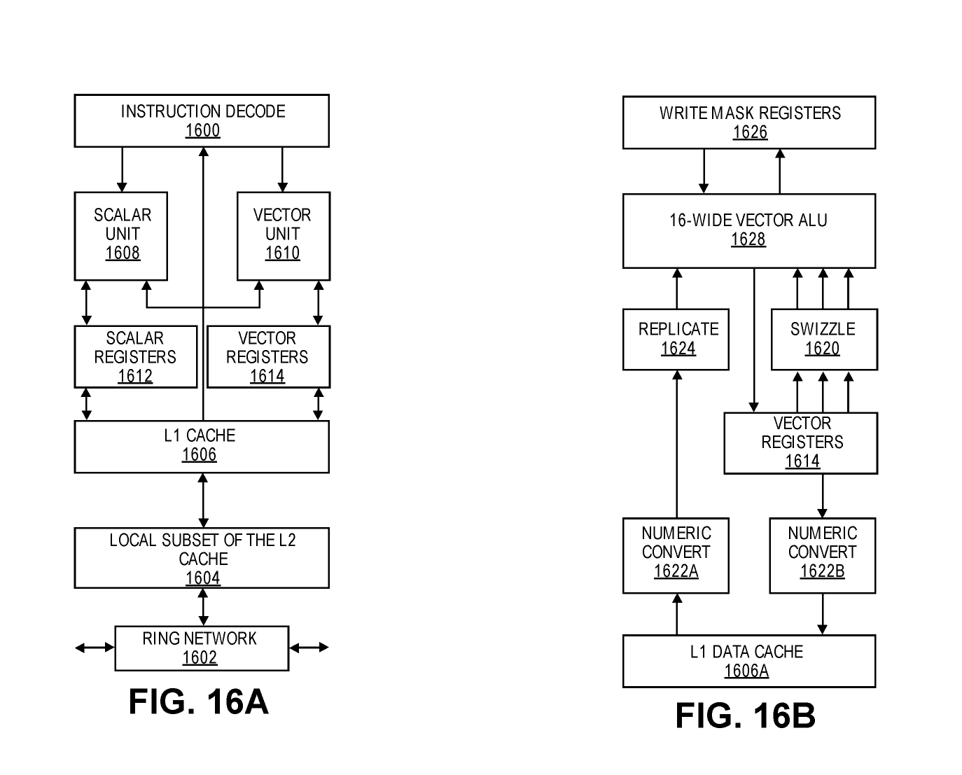

FIGS. 16A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 16A is a block diagram of a single processor core, along with its connection to the on-die interconnect network 1602 and with its local subset of the Level 2 (L2) cache 1604, according to embodiments of the invention. In one embodiment, an instruction decoder 1600 supports the x86 instruction set with a packed data instruction set extension. An L1 cache 1606 allows low-latency accesses to cache memory into the scalar and vector units. While in one embodiment (to simplify the design), a scalar unit 1608 and a vector unit 1610 use separate register sets (respectively, scalar registers 1612 and vector registers 1614) and data transferred between them is written to memory and then read back in from a level 1 (L1) cache 1606, alternative embodiments of the invention may use a different approach (e.g., use a single register set or include a communication path that allow data to be transferred between the two register files without being written and read back).

The local subset of the L2 cache 1604 is part of a global L2 cache that is divided into separate local subsets, one per processor core. Each processor core has a direct access path to its own local subset of the L2 cache 1604. Data read by a processor core is stored in its L2 cache subset 1604 and can be accessed quickly, in parallel with other processor cores accessing their own local L2 cache subsets. Data written by a processor core is stored in its own L2 cache subset 1604 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 16B is an expanded view of part of the processor core in FIG. 16A according to embodiments of the invention. FIG. 16B includes an L1 data cache 1606A part of the L1 cache 1604, as well as more detail regarding the vector unit 1610 and the vector registers 1614. Specifically, the vector unit 1610 is a 16-wide vector processing unit (VPU) (see the 16-wide ALU 1628), which executes one or more of integer, single-precision float, and double-precision float instructions. The VPU supports swizzling the register inputs with swizzle unit 1620, numeric conversion with numeric convert units 1622A-B, and replication with replication unit 1624 on the memory input. Write mask registers 1626 allow predicating resulting vector writes.

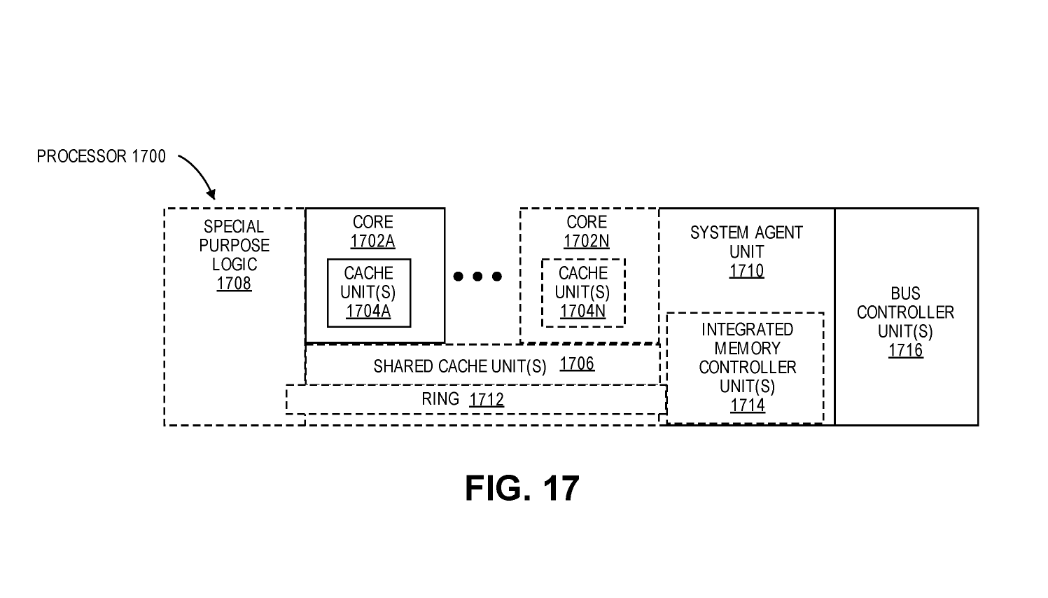

FIG. 17 is a block diagram of a processor 1700 that may have more than one core, may have an integrated memory controller, and may have integrated graphics according to embodiments of the invention. The solid lined boxes in FIG. 17 illustrate a processor 1700 with a single core 1702A, a system agent 1710, a set of one or more bus controller units 1716, while the optional addition of the dashed lined boxes illustrates an alternative processor 1700 with multiple cores 1702A-N, a set of one or more integrated memory controller unit(s) 1714 in the system agent unit 1710, and special purpose logic 1708.

Thus, different implementations of the processor 1700 may include: 1) a CPU with the special purpose logic 1708 being integrated graphics and/or scientific (throughput) logic (which may include one or more cores), and the cores 1702A-N being one or more general purpose cores (e.g., general purpose in-order cores, general purpose out-of-order cores, a combination of the two); 2) a coprocessor with the cores 1702A-N being a large number of special purpose cores intended primarily for graphics and/or scientific (throughput); and 3) a coprocessor with the cores 1702A-N being a large number of general purpose in-order cores. Thus, the processor 1700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1700 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1706, and external memory (not shown) coupled to the set of integrated memory controller units 1714. The set of shared cache units 1706 may include one or more mid-level caches, such as level 2 (L2), level 3 (L3), level 4 (L4), or other levels of cache, a last level cache (LLC), and/or combinations thereof. While in one embodiment a ring based interconnect unit 1712 interconnects the integrated graphics logic 1708 (integrated graphics logic 1708 is an example of and is also referred to herein as special purpose logic), the set of shared cache units 1706, and the system agent unit 1710/integrated memory controller unit(s) 1714, alternative embodiments may use any number of well-known techniques for interconnecting such units. In one embodiment, coherency is maintained between one or more cache units 1706 and cores 1702-A-N.

In some embodiments, one or more of the cores 1702A-N are capable of multi-threading. The system agent 1710 includes those components coordinating and operating cores 1702A-N. The system agent unit 1710 may include for example a power control unit (PCU) and a display unit. The PCU may be or include logic and components needed for regulating the power state of the cores 1702A-N and the integrated graphics logic 1708. The display unit is for driving one or more externally connected displays.

The cores 1702A-N may be homogenous or heterogeneous in terms of architecture instruction set; that is, two or more of the cores 1702A-N may be capable of execution the same instruction set, while others may be capable of executing only a subset of that instruction set or a different instruction set.

### Exemplary Computer Architectures

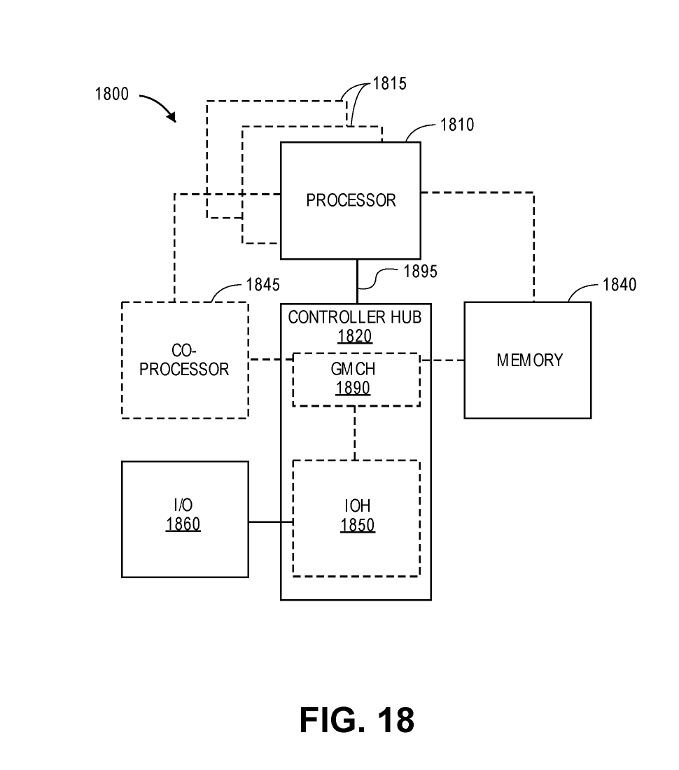

FIGS. 18-21 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 18, shown is a block diagram of a system 1800 in accordance with one embodiment of the present invention. The system 1800 may include one or more processors 1810, 1815, which are coupled to a controller hub 1820. In one embodiment the controller hub 1820 includes a graphics memory controller hub (GMCH) 1890 and an Input/Output Hub (IOH) 1850 (which may be on separate chips); the GMCH 1890 includes memory and graphics controllers to which are coupled memory 1840 and a coprocessor 1845; the IOH 1850 couples input/output (I/O) devices 1860 to the GMCH 1890. Alternatively, one or both of the memory and graphics controllers are integrated within the processor (as described herein), the memory 1840 and the coprocessor 1845 are coupled directly to the processor 1810, and the controller hub 1820 in a single chip with the IOH 1850.

The optional nature of additional processors 1815 is denoted in FIG. 18 with broken lines. Each processor 1810, 1815 may include one or more of the processing cores described herein and may be some version of the processor 1700.

The memory 1840 may be, for example, dynamic random access memory (DRAM), phase change memory (PCM), or a combination of the two. For at least one embodiment, the controller hub 1820 communicates with the processor(s) 1810, 1815 via a multi-drop bus, such as a frontside bus (FSB), point-to-point interface such as QuickPath Interconnect (QPI), or similar connection 1895.

In one embodiment, the coprocessor 1845 is a special-purpose processor, such as, for example, a high-throughput MIC processor, a network or communication processor, compression engine, graphics processor, GPGPU, embedded processor, or the like. In one embodiment, controller hub 1820 may include an integrated graphics accelerator.

There can be a variety of differences between the physical resources 1810, 1815 in terms of a spectrum of metrics of merit including architectural, microarchitectural, thermal, power consumption characteristics, and the like.

In one embodiment, the processor 1810 executes instructions that control data processing operations of a general type. Embedded within the instructions may be coprocessor instructions. The processor 1810 recognizes these coprocessor instructions as being of a type that should be executed by the attached coprocessor 1845. Accordingly, the processor 1810 issues these coprocessor instructions (or control signals representing coprocessor instructions) on a coprocessor bus or other interconnect, to coprocessor 1845. Coprocessor(s) 1845 accept and execute the received coprocessor instructions.

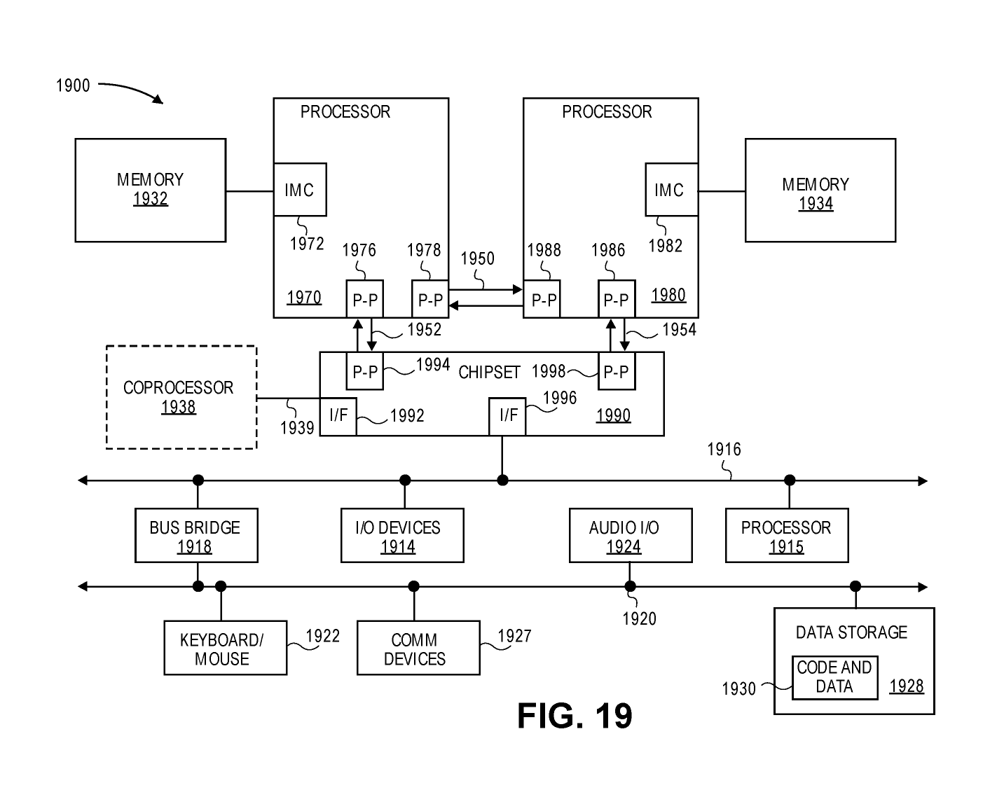

Referring now to FIG. 19, shown is a block diagram of a first more specific exemplary system 1900 in accordance with an embodiment of the present invention. As shown in FIG. 19, multiprocessor system 1900 is a point-to-point interconnect system, and includes a first processor 1970 and a second processor 1980 coupled via a point-to-point interconnect 1950. Each of processors 1970 and 1980 may be some version of the processor 1700. In one embodiment of the invention, processors 1970 and 1980 are respectively processors 1810 and 1815, while coprocessor 1938 is coprocessor 1845. In another embodiment, processors 1970 and 1980 are respectively processor 1810 coprocessor 1845.

Processors 1970 and 1980 are shown including integrated memory controller (IMC) units 1972 and 1982, respectively. Processor 1970 also includes as part of its bus controller units point-to-point (P-P) interfaces 1976 and 1978; similarly, second processor 1980 includes P-P interfaces 1986 and 1988. Processors 1970, 1980 may exchange information via a point-to-point (P-P) interface 1950 using P-P interface circuits 1978, 1988. As shown in FIG. 19, IMCs 1972 and 1982 couple the processors to respective memories, namely a memory 1932 and a memory 1934, which may be portions of main memory locally attached to the respective processors.

Processors 1970, 1980 may each exchange information with a chipset 1990 via individual P-P interfaces 1952, 1954 using point to point interface circuits 1976, 1994, 1986, 1998. Chipset 1990 may optionally exchange information with the coprocessor 1938 via a high-performance interface 1992. In one embodiment, the coprocessor 1938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1990 may be coupled to a first bus 1916 via an interface 1996. In one embodiment, first bus 1916 may be a Peripheral Component Interconnect (PCI) bus, or a bus such as a PCI Express bus or another third generation I/O interconnect bus, although the scope of the present invention is not so limited.

As shown in FIG. 19, various I/O devices 1914 may be coupled to first bus 1916, along with a bus bridge 1918 which couples first bus 1916 to a second bus 1920. In one embodiment, one or more additional processor(s) 1915, such as coprocessors, high-throughput MIC processors, GPGPU's, accelerators (such as, e.g., graphics accelerators or digital signal processing (DSP) units), field programmable gate arrays, or any other processor, are coupled to first bus 1916. In one embodiment, second bus 1920 may be a low pin count (LPC) bus. Various devices may be coupled to a second bus 1920 including, for example, a keyboard and/or mouse 1922, communication devices 1927 and a storage unit 1928 such as a disk drive or other mass storage device which may include instructions/code and data 1930, in one embodiment. Further, an audio I/O 1924 may be coupled to the second bus 1920. Note that other architectures are possible. For example, instead of the point-to-point architecture of FIG. 19, a system may implement a multi-drop bus or other such architecture.

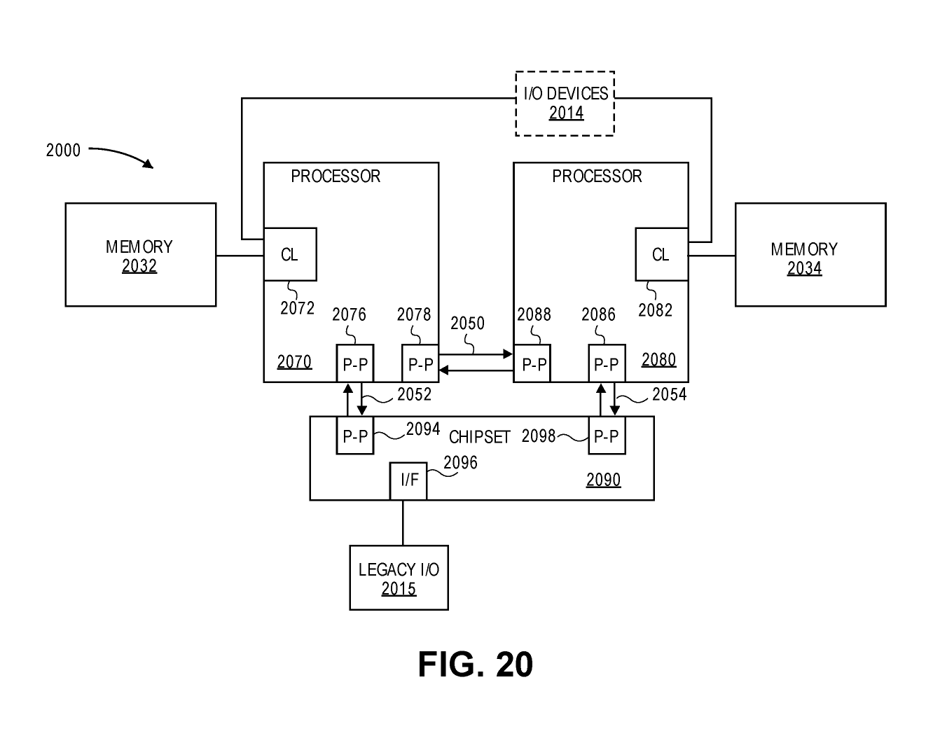

Referring now to FIG. 20, shown is a block diagram of a second more specific exemplary system 2000 in accordance with an embodiment of the present invention. Like elements in FIGS. 19 and 20 bear like reference numerals, and certain aspects of FIG. 19 have been omitted from FIG. 20 in order to avoid obscuring other aspects of FIG. 20.

FIG. 20 illustrates that the processors 1970, 1980 may include integrated memory and I/O control logic (“CL”) 1972 and 1982, respectively. Thus, the CL 1972, 1982 include integrated memory controller units and include I/O control logic. FIG. 20 illustrates that not only are the memories 1932, 1934 coupled to the CL 1972, 1982, but also that I/O devices 2014 are also coupled to the control logic 1972, 1982. Legacy I/O devices 2015 are coupled to the chipset 1990.

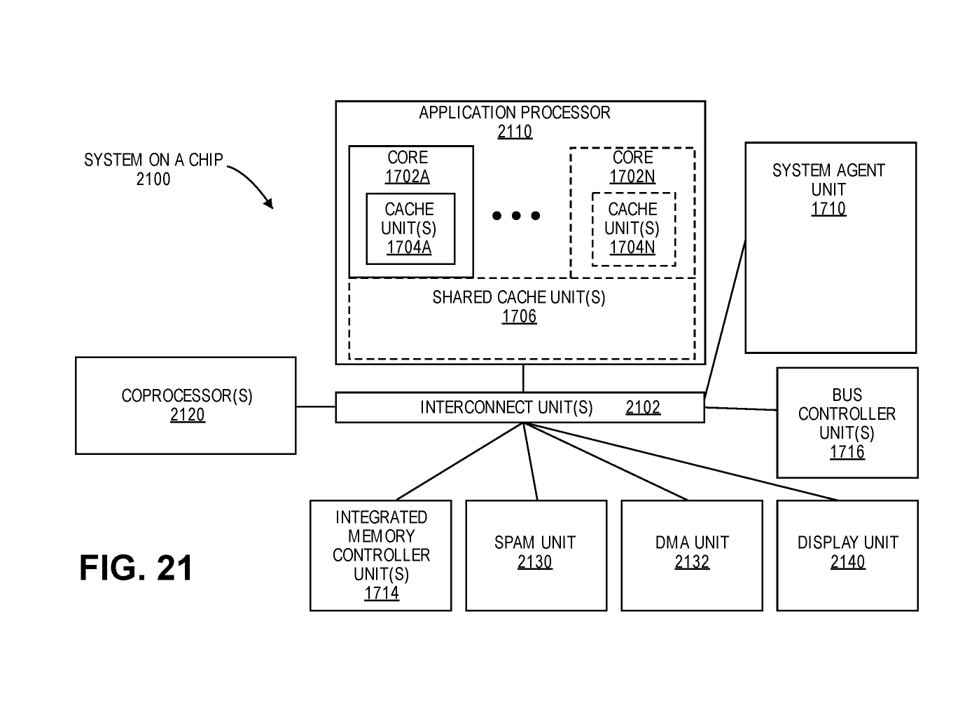

Referring now to FIG. 21, shown is a block diagram of a SoC 2100 in accordance with an embodiment of the present invention. Similar elements in FIG. 17 bear like reference numerals. Also, dashed lined boxes are optional features on more advanced SoCs. In FIG. 21, an interconnect unit(s) 2102 is coupled to: an application processor 2110 which includes a set of one or more cores 1702A-N, which include cache units 1704A-N, and shared cache unit(s) 1706; a system agent unit 1710; a bus controller unit(s) 1716; an integrated memory controller unit(s) 1714; a set or one or more coprocessors 2120 which may include integrated graphics logic, an image processor, an audio processor, and a video processor; an static random access memory (SRAM) unit 2130; a direct memory access (DMA) unit 2132; and a display unit 2140 for coupling to one or more external displays. In one embodiment, the coprocessor(s) 2120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1930 illustrated in FIG. 19, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Coding Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

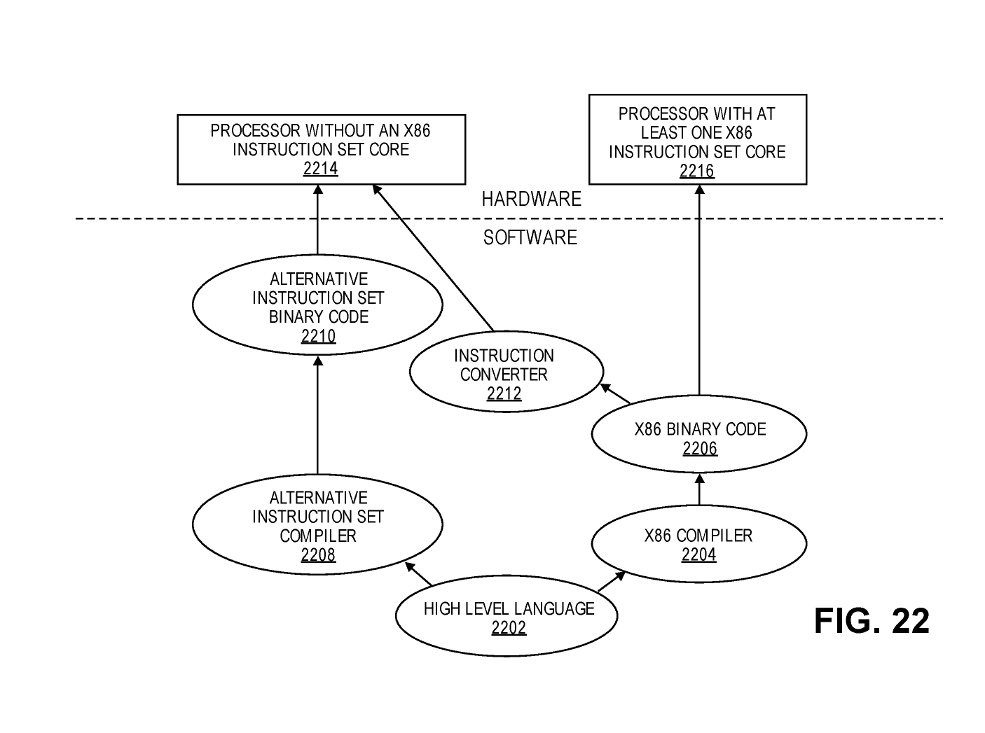

FIG. 22 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 22 shows a program in a high level language 2202 may be compiled using an x86 compiler 2204 to generate x86 binary code 2206 that may be natively executed by a processor with at least one x86 instruction set core 2216. The processor with at least one x86 instruction set core 2216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2204 represents a compiler that is operable to generate x86 binary code 2206 (e.g., object code) that can, with or without additional linkage processing, be executed on the processor with at least one x86 instruction set core 2216. Similarly, FIG. 22 shows the program in the high level language 2202 may be compiled using an alternative instruction set compiler 2208 to generate alternative instruction set binary code 2210 that may be natively executed by a processor without at least one x86 instruction set core 2214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2212 is used to convert the x86 binary code 2206 into code that may be natively executed by the processor without an x86 instruction set core 2214. This converted code is not likely to be the same as the alternative instruction set binary code 2210 because an instruction converter capable of this is difficult to make; however, the converted code will accomplish the general operation and be made up of instructions from the alternative instruction set. Thus, the instruction converter 2212 represents software, firmware, hardware, or a combination thereof that, through emulation, simulation or any other process, allows a processor or other electronic device that does not have an x86 instruction set processor or core to execute the x86 binary code 2206.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A computer-implemented method for multiplexing vector matching, the method comprising:
accessing a first vector having a vector length, wherein the first vector includes a plurality of vector portions of a vector portion length;
accessing a second vector having the vector length, wherein the second vector includes a same quantity of vector portions as the plurality of vector portions, and wherein the vector portions of the second vector are of the vector portion length;
comparing each of the plurality of vector portions of the first vector to each of the plurality of vector portions of the second vector; and
storing a result of the comparison in a third vector with at least one bit of the third vector corresponds to the comparison of the first plurality of vector portions and the second plurality of vector portions.

2. The computer-implemented method of claim 1 wherein each of the plurality of vector portions is aligned on a boundary of the vector portion length.

3. The computer-implemented method of claim 2 wherein the vector length is 64 bits.

4. The computer-implemented method of claim 3 wherein the vector portion length is 16 bits.

5. The computer-implemented method of claim 1 wherein the third vector includes a field that indicates if there were any matches resulting from the comparison.

6. The computer-implemented method of claim 5 wherein the field indicates a position within the third vector of a match indication.

7. The computer-implemented method of claim 1 wherein the accessing the first vector, the accessing the second vector, the comparison, and the storing the results is performed by a single machine language instruction.

8. A processor comprising:
at least one core including circuitry configured to perform a multiplexing vector comparison operation responsive to execution of one machine language instruction; and
at least one register to receive a result vector from the multiplexing vector comparison operation.

9. The processor of claim 8 configured to, responsive to execution of the one machine language instruction, execute the multiplexing vector comparison operation by loading a first vector into a first register, the first vector having a vector length, wherein the first vector includes a plurality of vector portions having a vector portion length, loading a second vector of the vector length into a second register, wherein the second vector includes the same quantity of vector portions as the plurality of vector portions, and wherein the vector portions of the second vector are of the vector portion length, executing a comparison of each of the plurality of vector portions of the first vector in the first register to each of the plurality of vector portions of the second vector in the second register, and storing a result vector in a third register with at least one bit of the result vector corresponding to each combination of the plurality of vector portions from the first vector and second vector, without executing a second machine language instruction.

10. The processor of claim 9 further comprising circuitry configured to control a sequence of comparisons required by the multiplexing vector comparison operation.

11. The processor of claim 9 further configured to not perform any branch prediction in conjunction with the execution of the one machine language instruction.

12. The processor of claim 11 further configured to not perform any speculative execution in conjunction with the execution of the one machine language instruction.

13. The processor of claim 9 wherein the multiplexing vector compare operation performs a bit-wise logical XNOR of each bit of each two-octet aligned portion of a first 64-bit register of the computer processor with each bit of each two-octet aligned portion of a second 64-bit register of the processor and then performs a logical AND on the results of each XNOR.

14. A machine-readable medium having instructions stored therein which, when executed, cause a processor to perform a set of operations, the set of operations comprising:
loading a first vector having a vector length, wherein the first vector includes a plurality of vector portions of a vector portion length;
loading a second vector having the vector length, wherein the second vector includes a same quantity of vector portions as the plurality of vector portions, and wherein the vector portions of the second vector are of the vector portion length;
performing a comparison of each of the plurality of vector portions of the first vector to each bit of each of the plurality of vector portions of the second vector; and
storing a result of the performing in a third vector with at least one bit of the third vector corresponds to each of the bit-wise logical AND of vector portions.

15. The machine-readable medium of claim 14, wherein the operations are invoked in their entirety by a single machine language instruction.

16. The machine-readable medium of claim 14, wherein the operations further specifically exclude branch prediction during performance of the operations.

17. The machine-readable medium of claim 16, wherein the operations further specifically exclude speculative execution within performance of the operations.

18. The machine-readable medium of claim 14, wherein the comparison is performed in parallel.

19. The machine-readable medium of claim 14, wherein the vector portions are aligned on boundaries of the vector portion length.

20. A computing device comprising:
a memory to store data and instructions;
an interconnect to communicatively couple the memory and a processor; and
the processor configured to include first circuitry to access a first vector having a vector length, wherein the first vector comprises a plurality of vector portions having a vector portion length, second circuitry to access a second vector of the vector length, wherein the second vector comprises a same quantity of vector portions as the plurality of vector portions, and wherein the vector portions of the second vector are of the vector portion length, third circuitry to perform a comparison of each of the plurality of vector portions of the first vector to each of the plurality of vector portions of the second vector, and fourth circuitry to store a result of the comparisons in a third vector with at least one bit of the third vector corresponding to each of the comparison of the pluralities of the first and the second vector portions, wherein the first, second, third and fourth circuitry are to perform all of their functions responsive to execution of one machine language instruction by the processor.

21. The computing device of claim 20, wherein the third circuitry is to perform all the comparisons in parallel.

22. The computing device of claim 20, wherein the third circuitry further includes sequencing circuitry configured to control a sequence of the bitwise logical XNOR and AND operations.

23. The computing device of claim 22, wherein the sequencing circuitry includes microcode.

24. The computing device of claim 22, wherein the sequencing circuitry includes a state machine.

25. The computing device of claim 20, wherein the processor is further configured to not perform any branch prediction in conjunction with the operation.

26. The computing device of claim 20, wherein the processor is further configured to not perform any speculative execution in conjunction with the operation.

27.-33. (canceled)
